(19) United States
(12) Patent Application Publication
(10) Pub. No.: US 2006/0064725 A1
(43) Pub. Date: Mar. 23, 2006

(54) Pilot acquisition and local clock calibration with reduced MIPS

(75) Inventors: Matthew Rabinowitz, Los Altos Hills, CA (US); Michael J. Sabin, Sunnyvale, CA (US); Jimmy K. Omura, San Francisco, CA (US)

Correspondence Address: MCDERMOTT WILL & EMERY LLP, 18191 VON KARMAN AVE., SUITE 500, IRVINE, CA, 92612-7108, US

(73) Assignee: Rosum Corporation

(21) Appl. No.: 10/945,878

(22) Filed: Sep. 22, 2004

(51) Int. Cl. H04N 7/20

(52) U.S. Cl. 725/68

(57) ABSTRACT

The present invention provides a method, system, and apparatus for estimating a pilot frequency of a television broadcast signal at a receiver. In one aspect, the receiver constitutes a mobile device that uses the estimated pilot frequency to facilitate the determination of position location of the mobile device. The receiver includes a processor which estimates the pilot frequency by computing a baseband version of the pilot signal relative to a reference frequency, defining time-shifted segments for the pilot signal and its baseband version, computing phase correction terms using the pilot signal and its baseband version, phase correcting each received signal segment, and estimating the pilot frequency. In another aspect of the invention, a phase-locked-loop is used to track the phase of the incoming pilot signal. The loop filter and/or the phase of the numerically controlled oscillator is scaled to account for the non-integer nature of samples within the received segments.

### CROSS-REFERENCES TO RELATED APPLICATIONS

This application is related to U.S. Non-provisional patent application Ser. No. 10/003,128, “Robust Data Transmission Using Broadcast Digital Television Signals,” by Jimmy K. Omura, James J. Spilker, Jr. and Matthew Rabinowitz, filed Nov. 14, 2001; U.S. Non-provisional patent application Ser. No. 09/887,158, “Position Location using Broadcast Digital Television Signals,” by James J. Spilker and Matthew Rabinowitz, filed Jun. 21, 2001; U.S. Non-provisional patent application Ser. No. 09/932,010, “Position Location using Terrestrial Digital Video Broadcast Television Signals,” by James J. Spilker and Matthew Rabinowitz, filed Aug. 17, 2001; U.S. Non-provisional patent application Ser. No. 10/054,302, “Position Location using Broadcast Analog Television Signals,” by James J. Spilker and Matthew Rabinowitz, filed Jan. 22, 2002; U.S. Non-provisional Patent Applications Ser. No. ______ (TBS, Attorney Docket Number RSM008001), “Position Location Using Ghost Canceling Reference Television Signals,” by James J. Spilker and Matthew Rabinowitz, filed (TBS); and U.S. Non-provisional patent application Ser. No. 10/054,262, “Time-Gated Delay Lock Loop Tracking Of Digital Television Signals,” by James J. Spilker and Matthew Rabinowitz, filed Jan. 22, 2002; U.S. patent application Ser. No. 10/159,478, “Position Location using Global Positioning Signals Augmented by Broadcast Television Signals,” by Matthew Rabinowitz and James J. Spilker, filed May 31, 2002; and U.S. Non-provisional Patent Applications Ser. No. ______ (TBS, Attorney Docket Number RSM031001), “Position Location using Integrated Services Digital Broadcasting—Terrestrial (ISDB-T) Broadcast Television Signals,” by James J. Spilker and Matthew Rabinowitz, filed (TBS); U.S. patent application Ser. No. 10/292,975, “Radio Frequency Device for Receiving TV Signals and GPS Satellite Signals and Performing Positioning,” by Matthew Rabinowitz and James J. Spilker, filed Nov. 13, 2002; the disclosures thereof are incorporated by reference herein in their entirety.

### INCORPORATION BY REFERENCE

This application hereby incorporates by reference in its entirety for following documents: 1) B. Parkinson and J. Spilker, Jr. Global Positioning System-Theory and Applications, AIAA, Washington, D.C., 1996, Vol. 1, Chapter 17 Tropospheric Effects on GPS by J. Spilker, Jr., 2) J. Spilker, Jr., Digital Communications by Satellite, Prentice-Hall, Englewood Cliffs, N.J., 1977, 1995, and 3) B. W. Parkinson and J. Spilker, Jr., Global Positioning System-Theory and Application, Volume 1, AIAA, Washington, D.C. 1996.

### BACKGROUND OF THE INVENTION

1. Field of the Invention

The present invention relates generally to position location, and specifically to a receiver that estimates the pilot frequency of a television signal and tracks the phase of the pilot signal.

2. Description of the Related Art

The Global Positioning System (GPS) technology has revolutionized the field of navigation and position location. Initially devised in 1974, the GPS is based on a constellation of 24 on-orbit satellites in 12 hour circular, inclined orbits. Each satellite transmits a known pseudo-noise signal synchronized to an on-board precision atomic clock. The transmitted pseudo-noise signals can be precisely tracked by a receiver at an unknown location to determine pseudo-ranges. By tracking four or more satellites, one can determine precise position in three dimensions in real time, world-wide. More details on the operation of GPS are provided in (1) B. W. Parkinson and J. J. Spilker, Jr., Global Positioning System-Theory and Applications, Volumes I and II, AIAA, Washington, D.C. 1996, and (2) J. Spilker, Jr., Digital Communications by Satellite, Prentice-Hall, Englewood Cliffs, N.J., 1977, 1995, which are incorporated by reference herein in their entirety.

However, the effectiveness of GPS is limited in some situations. Because the GPS signals are transmitted at relatively low power levels (less than 100 watts) and over great distances, the received signal strength is relatively weak (on the order of 31 160 dBW as received by an omni-directional antenna). Thus the signal is marginally useful or not useful at all in the presence of line-of-sight blockage or while the receiver is inside a building.

This limitation or shortcoming of GPS technology can be overcome or ameliorated by employing position location technologies based on receiving broadcast television signals. High power, high bandwidth, and superior geometries make various broadcast television signals ideal candidates for augmenting or improving position location where the GPS technology fails. For example, various digital television (DTV) broadcast signals contain embedded synchronization codes which can be used for position determination purposes. The ATSC standard in the United States, the DVB standard in Europe, and the ISDB-T standard in Japan all employ an embedded synchronization code which is used to probe the transmission channel and mitigate the effects of multipath in a digital TV receiver. In order to be effective for channel modeling and multipath mitigation, these synchronization codes have wide bandwidths, narrow time autocorrelation functions, and high power levels. These features make these synchronization codes ideal for positioning, in particular for indoors positioning where multipath effects are severe and GPS signals may not penetrate. In addition, the Ghost-Canceling Reference (GCR) signals embedded in analog television broadcasts can be used for precise ranging. In recent years, analog television broadcasts have started to insert into their broadcasts a synchronization code termed the Ghost-Canceling Reference, which is used for multipath mitigation on analog signals in TV receivers that digitize the signal. High power characteristics and wide availability of GCR signals make them suitable for position location. Other test signals inserted in the analog broadcasts, such as the multiburst signal, may also be used for position determination. In the GPS system, autocorrelation of a known Pseudo-Random-Number (PRN) sequence signal (i.e., a pseudo-noise signal) is used to determine pseudo-ranges. Other test signals inserted in the analog broadcasts, such as the multiburst signal, may also be used for positioning.

There has even been a proposed system using conventional analog National Television System Committee (NTSC) television signals to determine position. This proposal is found in a U.S. patent entitled “Location Determination System And Method Using Television Broadcast Signals,” U.S. Pat. No. 5,510,801, issued Apr. 23, 1996. However, the technique described the use of the horizontal and vertical synchronization pulses which were intended only for relatively crude synchronization of the TV set sweep circuitry, and cannot achieve the level of positioning accuracy or reliability of the disclosed location technology. Further, in 2006 the Federal Communication Commission (FCC) will consider turning off NTSC transmitters and reassigning that valuable spectrum so that it can be auctioned for other purposes deemed more valuable.

A strong emphasis is being placed on the mobile user for the type of services that DTV can provide. For example, efforts are ongoing in Korea and Japan to generate cellular handsets which include television tuners for the purpose of receiving television on the mobile device as well as data conveyed using the DTV channel. A correct design of the receiver architecture, as described in this disclosure will enable data reception, as well as location using TV signals in combination with GPS.

One problem with conventional position determination technology relates to the capacity and processing circuitry of the user device. The computations to ultimately determine position location, particularly when using both GPS and television signals, can be complex to say the least. In many instances, the position location technology is placed in a compact mobile device. A typical mobile device has finite processing power, limited analog front end sophistication, a relatively limited power source and restricted memory capacity. In the case of a handheld receiver or telephone with receiver functionality for position location, a limited amount of real estate may exist on the printed circuit board(s) to implement sophisticated circuitry for managing receiver functions. Additionally, the more circuitry designed onto the card, generally the greater the battery consumption, which may be especially undesirable for mobile devices such as transceivers or cellular telephones.

These problems and limitations that exist with mobile devices are exacerbated in light of the objective that the receiver perform position computations in as close to real time as possible. This may be especially true where the user device is in motion, and it is desirable to obtain as high a quality position measurement as possible. An effective method and system is needed to perform the required computations for position location as expediently as possible and using minimal computational requirements given the limitations on size, memory capacity, and processing power on many of these user devices.

To this end, one possible approach is to employ a “software” based receiver device which uses, in addition to an analog front end for receiving, filtering, amplifying and digitizing the broadcast television signal, a processor such as a DSP or microprocessor to sample a sequence of the downconverted broadcast signal, and then to process the sample by executing necessary routines that manipulate the digitized signal. Such a software implementation, designed properly, can have the advantages of mitigating multipath interference and reducing the complexity of circuitry on the integrated circuits that are embedded within the mobile device. However, given the critical timing requirements and relative sophistication of a digital broadcast signal, even a solution using a processor or DSP to perform primary correlation functions can produce inaccurate results, and without any appreciable decrease in computational requirements. Additionally, the traditional correlation process for identifying time offsets between transmissions of a known code sequence and its arrival at a mobile receiver can add considerable complexity into the mix. In particular, for each signal segment interval (e.g., a single packet of information in a television broadcast signal), a separate correlation operation may need to be performed to extract timing information from each segment. As the number of intervals increase, the number of required correlation operations likewise increases, which taxes the processing unit of the receiver and limits the capability of smaller mobile devices to produce position-related information (either for itself or a location server or other computing device) in near real time as is highly desirable in such mobile applications.

Another problem relates to the acquisition of the carrier frequency in the received signal. Generally, the carrier frequency of a transmitted radio signal can drift due to, among other reasons, oscillator instability. For many applications, including a software-based receiver, the receiver may need to rapidly acquire the unknown carrier frequency of the radio signal. Acquiring the carrier frequency is necessary to accurately retime the signal and to convert the received signal to a baseband format for further processing. Where the estimated pilot frequency is inaccurate, these errors will generally be amplified in ensuing calculations resulting in inaccuracies in position determination. Further, where the estimation of the pilot frequency is too slow, the software receiver may be unable to operate in near-real time, resulting in poor performance of a mobile receiver.

Accurately tracking the pilot tone of a television signal is also problematic. The problem stems in part from the fact that, in many television signal formats, the segment length is a non-integer value and hence a phase-locked-loop for tracking the pilot tone cannot be clocked at a precise frequency without introducing potentially unacceptable amounts of jitter into the phase-corrected output signal.

As the demand for progressively smaller and more compact mobile devices continues, it becomes more desirable and advantageous to implement a processor-based solution that eliminates much of the hardware otherwise necessary to process the signal and extract critical timing information for purposes of position location. Processing requirements include the need for a novel and robust method for rapidly acquiring a pilot frequency and for tracking the received signal in software using an appropriately configured phase-locked-loop solution.

### SUMMARY OF THE INVENTION

The present invention addresses the foregoing needs and objectives by providing a receiver apparatus and method that uses a processor to rapidly estimate the pilot frequency of a received pilot signal embedded in a television broadcast signal. The present invention discloses in another aspect a method and apparatus for tracking the pilot phase of a received signal.

In one aspect of the present invention, a method of estimating a frequency of a pilot signal at a receiving device comprises: computing a baseband version of the pilot signal relative to a reference frequency; defining time-shifted segments for the pilot signal and for the baseband version of the pilot signal; computing, for each of the time-shifted segments, phase correction terms using the pilot signal and the baseband version of the pilot signal; phase-correcting the each of the time-shifted segments by multiplying the each of the time-shifted segments by its associated phase-correction term; accumulating the phase-corrected time shifted-segments; and estimating the pilot frequency using the accumulated phase-corrected time-shifted segments.

In another aspect of the invention, a receiving apparatus for estimating a pilot frequency of a television broadcast signal comprises (a) an antenna for receiving the television broadcast signal; (b) a filter coupled to the antenna for filtering the television broadcast signal; (c) an amplifier coupled to the filter; (d) an analog-to-digital converter coupled to the amplifier for digitizing the television broadcast signal; and (e) a processor coupled to the analog digital converter, the processor configured to estimate the pilot frequency by: (i) computing a baseband version of the pilot signal relative to a reference frequency; (ii) defining time-shifted segments for the pilot signal and for the baseband version of the pilot signal; (iii) computing, for each of the time-shifted segments, phase correction terms using the pilot signal and the baseband version of the pilot signal; (iv) phase-correcting the each of the time-shifted segments; (v) accumulating the phase-corrected time shifted-segments; and (vi) estimating the pilot frequency using the accumulated phase-corrected time-shifted segments.

In yet another aspect of the invention, a receiver circuit for estimating the pilot frequency of a television broadcast signal, comprises: an antenna for receiving the television broadcast signal; filtering and amplifying circuitry coupled to the antenna; an analog to digital converter coupled to the filtering and amplifying circuitry; a digital processor coupled to the analog to digital converter for receiving a digitized version of the television signal, the processor configured to estimate the pilot frequency within the television broadcast signal by using an ideal pilot carrier frequency estimate and by selecting a sufficient number of segments of the television broadcast signal to produce a threshold signal-to-noise ratio; and a memory circuit coupled to the digital processor.

In still another aspect of the invention, a receiver circuit for estimating the pilot frequency of a television broadcast signal comprises: an antenna for receiving the television broadcast signal; filtering and amplifying circuitry coupled to the antenna; an analog to digital converter coupled to the filtering and amplifying circuitry; a local oscillator; a digital processor coupled to the analog to digital converter and to the local oscillator for receiving a digitized version of the television signal, the processor configured to estimate the pilot frequency within the television broadcast signal and to calibrate the local oscillator using the estimated pilot frequency; and a memory circuit coupled to the digital processor.

In still another aspect of the invention, a receiver comprising a phase-locked loop (PLL) for tracking the phase of a pilot signal in a television broadcast signal having segments comprising a non-integer number of samples, comprises a loop filter; a numerically-controlled oscillator (NCO) coupled to the loop filter, the NCO comprising an output having an estimated phase value; and a phase detector coupled to the loop filter for comparing the phase of the pilot signal with the estimated phase value output; wherein a center frequency of the NCO is scaled by a quantity sufficient to adjust the estimated phase value output from the NCO to reduce an average jitter value in the estimated phase value output below a threshold level.

In still another aspect of the invention, computer-readable media embodying a program of instructions executable by a computer program to perform a method of estimating a pilot frequency embedded in a television broadcast signal comprises: computing a baseband version of the pilot signal relative to a reference frequency; defining time-shifted segments for the pilot signal and for the baseband version of the pilot signal; computing, for each of the time-shifted segments, phase correction terms using the pilot signal and the baseband version of the pilot signal; phase-correcting the each of the time-shifted segments by multiplying the each of the time-shifted segments by its associated phase-correction term; accumulating the phase-corrected time shifted-segments; and estimating the pilot frequency using the accumulated phase-corrected time-shifted segments.

Other and further objects and advantages of the present invention will be further understood and appreciated by those skilled in the art by reference to the following specification, claims, and drawings.

### BRIEF DESCRIPTION OF THE DRAWINGS

FIG. 1 illustrates an overview of a system environment in which the present invention is implemented.

FIG. 2 illustrates a flow chart in accordance with the present invention.

FIG. 3 depicts the geometry of a position determination using 3 DTV transmitters.

FIG. 4 shows a time switching sequence for an integrated TV/GPS receiver according to some implementations.

FIG. 5 shows a receiver capable of processing both television signals and GPS signals for position determination according to some implementations.

FIG. 6 shows an embodiment for performing a coherent digital downconversion.

FIG. 7 shows an architecture for implementing a phase-locked loop to acquire the incident carrier signal.

FIG. 8 shows a direct downconversion architecture for processing the TV signals.

FIG. 9 shows an exemplary ATSC signal frame.

FIG. 10A shows a field synchronization segment of the ATSC signal frame from FIG. 9.

FIG. 10B shows a data segment of the ATSC signal frame from FIG. 9.

FIG. 11 shows an ATSC digital television signal in a coded 8-VSB baseband data segment format.

FIG. 12 is a block diagram of an algorithm for estimating correlation peaks associated with pseudo-range estimation in accordance with an embodiment of the present invention.

FIG. 13 is a portion of a transfer function of an impulse response filter in accordance with an embodiment of the present invention.

FIG. 14 is a Finite Impulse Response (FIR) filter in accordance with an embodiment of the present invention.

FIG. 15 is a representation of the frequency spectra of a digital television signal and associated transfer function in accordance with an embodiment of the present invention.

FIGS. 16A and 16B are a flow diagram of an algorithm for computing a pseudo-range of a received television signal in accordance with an embodiment of the present invention.

FIG. 17 depicts a simplified block diagram of a receiver in accordance with an embodiment of the present invention.

FIG. 18 shows conceptual diagram of a system for locating the position of radio tags used for tracking animals in accordance with an embodiment of the present invention.

FIG. 19 shows a block diagram of a receiver used for detecting and locating the position of radio tags in accordance with an embodiment of the present invention.

FIG. 20 is a block diagram of a matched filter in accordance with an embodiment of the present invention.

FIG. 21 represents a graph of the correlator output of the matched filter in accordance with an embodiment of the present invention.

FIG. 22 is a graph of a binary phase shift keyed sequence including a pilot signal and a pseudo-random sequence in accordance with an embodiment of the present invention.

FIG. 23 is a block diagram of a phase-locked loop (PLL) used in the receiver in accordance with an embodiment of the present invention.

FIG. 24 is a graph that shows a transient response of a PLL using ideal clocking in accordance with an embodiment of the present invention.

FIG. 25 is a graph that shows a transient response of a PLL using sample-time clocking in accordance with an embodiment of the present invention.

FIG. 26 is a block diagram of a modified phase-locked loop (PLL) used in the receiver in accordance with an embodiment of the present invention.

FIG. 27 is a graph which demonstrates the behavior of a PLL using scaling under sample-time clocking in accordance with an embodiment of the present invention.

FIG. 28 is a graph which demonstrates the behavior of a PLL incorporating NCO scaling and omitting loop filter scaling in accordance with an embodiment of the present invention.

FIG. 29 is a flowchart demonstrating a method for acquiring a pilot frequency in accordance with an embodiment of the present invention.

### DETAILED DESCRIPTION OF THE PREFERRED EMBODIMENTS

In general, in one aspect, the invention features a method and apparatus for receiving TV and GPS signals and determining position location in a manner that provides for rapid signal synchronization while minimizing receiver computational requirements. The invention also features a method and apparatus for coherent accumulation of intermediate frequency (IF) signals, which in turn permits real time or near real-time operation using a software implementation of the receiver. The invention further discloses a method for rapid open-loop acquisition of the pilot frequency of the received radio signal. The receiver described herein can be a receiver used either solely for receiving terrestrial or television broadcast signals, for receiving both television and GPS signals, or for receiving different types of television broadcast signals for position determination purposes. In certain embodiments, the receiver described herein is implemented in software on a microprocessor or general purpose CPU. In other embodiments, the receiver may be implemented using one or more dedicated integrated circuits which may include digital signal processors, application-specific integrated circuits (ASICs), programmable logic devices, and the like. In one embodiment, the user device employs a digital signal processor (DSP) programmed to perform the computations for pseudo-range determination and position location on mobile devices.

The receiver as described herein need not be limited to a handheld receiver, but may also encompass other types of receivers, including those in automobiles or other transport mechanisms (such as airplanes, etc.). The term receiver is intended to broadly encompass all such classes of device which contain the functionality for receiving and properly interpreting broadcast television and/or GPS signals for the purpose of calculating location, whether alone or in conjunction with other devices or server-based equipment.

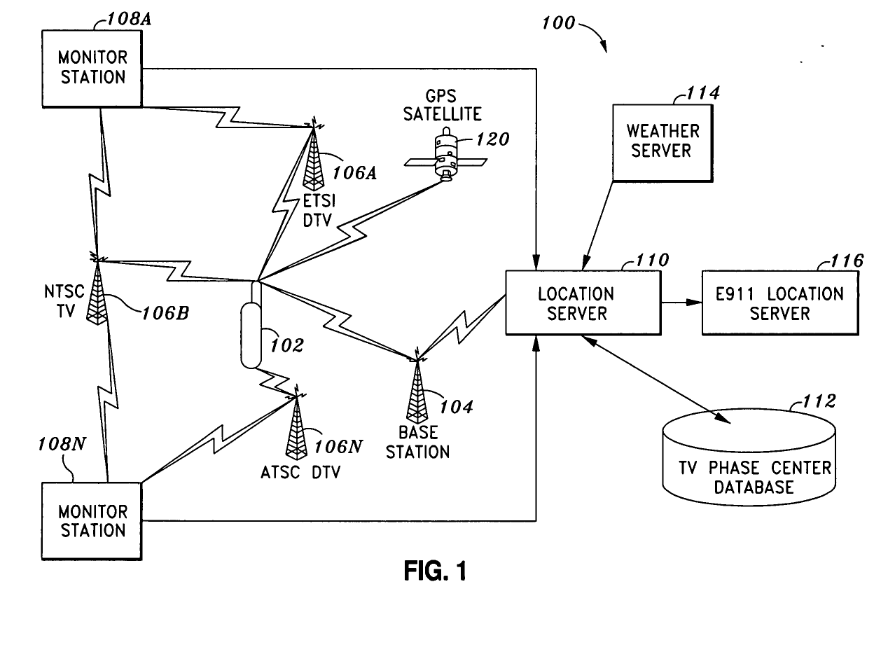

FIG. 1 illustrates an overview of a system environment in which the present invention may be implemented. FIG. 1 is merely an example of one of many possible system implementations in which the present invention finds utility, and a variety of other solutions or configurations may be contemplated without departing from the scope of the invention. As shown in FIG. 1, user terminal 102 communicates over an air link with a base station 104. In one embodiment, the user terminal 102 is a wireless telephone and the base station 104 is a wireless telephone base station. Base station 104 can be a part of a mobile metropolitan area network (“MAN”) or a wide area network (“WAN”) without departing from the scope of the present invention. Additionally, the phrases “mobile receiver,” “user terminal,” “user device” or “mobile device” refer to any device capable of implementing the position determination techniques described herein. Examples of user terminals include PDAs (Personal Digital Assistants), mobile phones, cars and other vehicles, and any object which could include a chip or software implementing the position determination techniques described herein. Further, the terms “user terminal” or “mobile device” are not intended to be limited to units which are “terminals” or which are operated by “users.”

Position Location Performed by a Location Server

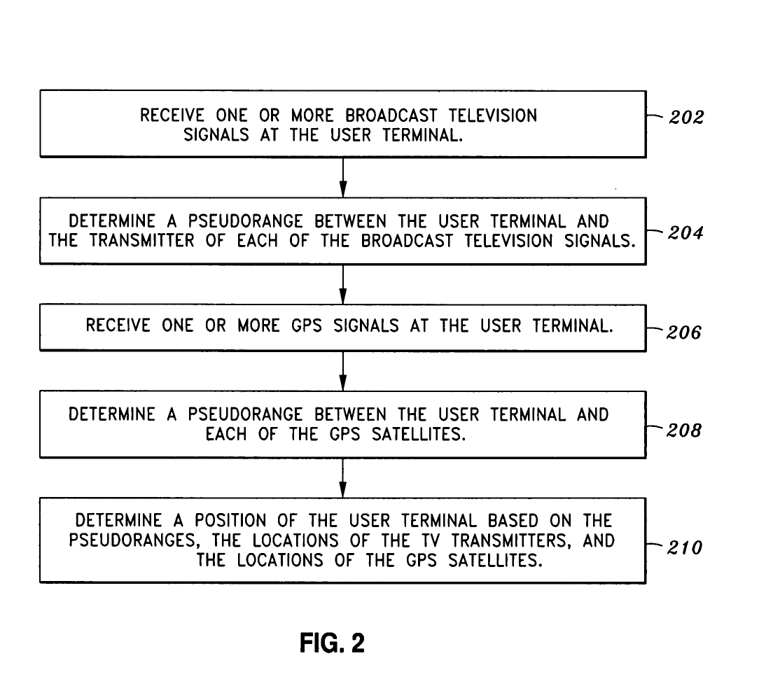

FIG. 2 illustrates an operation of the implementation 100 shown in FIG. 1. User terminal 102 receives broadcast signals from one or more TV transmitters 106A and 106B through 106N (step 202). Referring to FIG. 1, TV transmitter 106A is an ETSI transmitter, TV transmitter 106B is an NTSC transmitter, and TV transmitter 106N is an ATSC transmitter, although other combinations may be contemplated, including, for example, transmitters of the ISDB signal used in Japan.

Various methods can be used to select which TV channels to use in position location. In one implementation, a location server 110 tells user terminal 102 of the best TV channels to monitor. In some implementations, user terminal 102 exchanges messages with location server 110 by way of base station 104. User terminal 102 may select TV channels to monitor based on the identity of base station 104 and a stored table correlating base stations and TV channels. In some implementations, user terminal 102 can accept a location input from the user that provides a general indication of the location of the user terminal, such as the name of the nearest city; and uses this information to select TV channels for processing. User terminal 102 may scan available TV channels to assemble a fingerprint of the location based on power levels of the available TV channels. User terminal 102 compares this fingerprint to a stored table that matches known fingerprints with known locations to select TV channels for processing. This selection may be based on the power levels of the DTV channels, as well as the directions from which each of the signals are arriving, so as to minimize the dilution of precision (DOP) for the position calculation.

User terminal 102 determines a pseudo-range between the user terminal and each TV transmitter 106 (step 204). Each pseudo-range represents the time difference (or equivalent distance) between a time of transmission from a transmitter 106 of a component of the TV broadcast signal and a time of reception at the user terminal 102 of the component, as well as a clock offset at the user terminal.

User terminal 102 may transmit the pseudo-ranges to location server 110. In certain implementations, location server 110 is implemented as a general-purpose computer executing software designed to perform the operations described herein. In another implementation, location server is implemented as one or more ASICs (application-specific integrated circuit), DSPs or other circuit or device. In one embodiment, location server 110 is implemented within or near base station 104.

The TV signals are also received by a plurality of monitor units 108A through 108N. Each monitor unit 108 can be implemented as a small unit including a transceiver and processor, and can be mounted in a convenient location such as on a utility pole, TV transmitter 106, base station 104, or the like. In still other implementations, monitor units 108 may be implemented on satellites.

Each monitor unit 108 measures, for each of the TV transmitters 106 from which it receives TV signals, a time offset between the local clock of that TV transmitter and a reference clock. In some implementations the reference clock is derived from GPS signals. The use of a reference clock permits the determination of the time offset for each TV transmitter 106 when multiple monitor units 108 are used, since each monitor unit 108 can determine the time offset with respect to the reference clock. Thus, offsets in the local clocks of the monitor units 108 do not affect these determinations. Monitor units 108 are described in greater detail in U.S. Ser. Nos. 09/887,158, 09/932,010, and 10/054,302, the disclosures thereof which are incorporated by reference herein in their entirety.

In another implementation, no external time reference is needed. According to this implementation, a single monitor unit 108 receives TV signals from all of the same TV transmitters as does user terminal 102. In effect, the local clock of the single monitor unit functions as the time reference.

In some implementations, each time offset is modeled as a fixed offset. In another implementation each time offset is modeled as a second order polynomial fit of the form
T_{offset}(t)=a+b(t−T₀)+c(t−T₀)² (1)
that can be described by parameters a, b, c, and T₀ with t as the time variable. In either implementation, each measured time offset may be transmitted periodically to the location server 110 using the Internet, a secured modem connection, as part of the actual DTV broadcast data, or the like. In some implementations, the location of each monitor unit 108 is determined using GPS receivers.

Location server 110 receives information describing the phase center (i.e., the location) of each TV transmitter 106 from a database 112. In some implementations, the phase center of each TV transmitter 106 is measured by using monitor units 108 at different locations to measure the phase center directly. In another implementation, the phase center of each TV transmitter 106 is measured by surveying the antenna phase center.

In some implementations, location server 110 receives weather information describing the air temperature, atmospheric pressure, and humidity in the vicinity of user terminal 102 from a weather server 114. The weather information is available from the Internet and other sources such as NOAA. Location server 110 determines tropospheric propagation velocity from the weather information using techniques such as those disclosed in B. Parkinson and J. Spilker, Jr. Global Positioning System-Theory and Applications, AIAA, Washington, D.C., 1996, Vol. 1, Chapter 17 Tropospheric Effects on GPS by J. Spilker, Jr.

Location server 110 can also receive from base station 104 information which identifies a general geographic location of user terminal 102. For example, in a cellular application, the information can identify a cell or cell sector within which a cellular telephone is located. This information may be used, among other purposes, for ambiguity resolution.

User terminal 102 receives GPS signals from one or more GPS satellites 120 (step 206). User terminal 102 also receives almanac data describing Doppler shifts and pseudo-noise numbers for GPS satellites 120, as described below. User terminal 102 determines a pseudo-range between the user terminal and each GPS satellite 120 (step 208). Each pseudo-range represents the time difference (or equivalent distance) between a time of transmission from a GPS satellite 120 of a component of the GPS signal and a time of reception at the user terminal 102 of the component, as well as a clock offset, e.g., at the GPS satellite. In this implementation, user terminal 102 transmits the pseudo-ranges to location server 110.

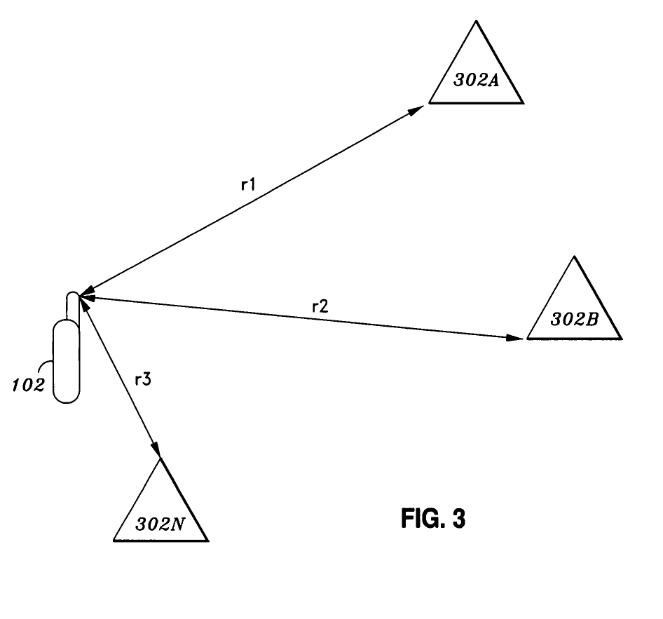

Location server 110 determines a position of the user terminal based on the pseudo-ranges, a location of each of the TV transmitters 106, and a location of the GPS satellites 120 (step 210). FIG. 3 depicts the geometry of a position determination using three transmitters 302. Transmitters 302 can be all TV transmitters, all GPS transmitters, or any combination thereof. Transmitter 302A is located at position (x₁, y₁, z₁). The range between user terminal 102 and transmitter 302A is r₁. Transmitter 302B is located at position (x₂, y₂, z₂). The range between user terminal 102 and transmitter 302B is r₂. Transmitter 302N is located at position (x₃, y₃, z₃). The range between user terminal 102 and transmitter 302N is r₃.

Location server 110 may adjust the value of each pseudo-range according to the tropospheric propagation velocity and the time offset for the corresponding transmitter 302. Location server 110 uses the phase center information from database 112 to determine the position of each transmitter 302.

User terminal 102 makes three or more pseudo-range measurements to solve for three unknowns, namely the position (x, y) and clock offset T_{offset}(t), which in this embodiment represents a clock offset of user terminal 102. It is assumed that the altitude of the user terminal is known to within the necessary degree of accuracy and only the latitude and longitude of the user terminal need to be precisely determined. Of course, it is possible to solve for position of the user terminal in three dimensions, namely (x, y, z) assuming that four or more transmitters are available, and the geometry of those transmitters is sufficient. It would be clear to one skilled in the art how to adjust the techniques described herein for a 3-Dimensional position fix.

The three pseudo-range measurements pr₁, pr₂ and pr₃ are given by
pr₁=r₁+T_{offset}(t) (2a)
pr₂=r₂+T_{offset}(t) (3a)
pr₃=r₃+T_{offset}(t) (4a)
The three ranges can be expressed as
r₁=|X−X₁| (5)
r₂=|X−X₂| (6)
r₃=|X−X₃| (7)
where X represents the three-dimensional vector position (x, y, z) of user terminal, X₁ represents the three-dimensional vector position (x₁, y₁, z₁) of transmitter 302A, X₂ represents the three-dimensional vector position) (x₂, y₂, z₂) of transmitter 302B, and X₃ represents the three-dimensional vector position (x₃, y₃, z₃) of transmitter 302N. These relationships produce three equations in which to solve for the three unknowns x, y, and T_{offset}(t). Notice that in the case that only latitude and longitude are required, location server 110 assumes some estimate for z and does not solve for it as for the other unknown co-ordinates. In one implementation, using a terrain map, the initial estimate of z can be iteratively refined based on the computed values for x and y. In another implementation, location server 110 actively solves for z Location server 110 solves these equations according to conventional well-known methods. In an E911 application, the position of user terminal 102 is transmitted to E911 location server 116 for distribution to the proper authorities. In another application, the position is transmitted to user terminal 102.

A high quality oscillator in the user device generally cannot be assumed. Therefore, techniques for projecting the measurements at the user terminal 102 to a common instant in time (common time instant) are described. Note that this is not necessary if the clock of the user terminal 102 is stabilized or corrected using a signal from the cellular base station or a DTV transmitter 106. In cases where the user clock is not stabilized, or corrected, the user clock offset can be considered to be a function of time, T_{offset}(t). For a small time interval, Δ, the clock offset, T_{offset}(t), can be modeled by a constant and a first order term. Namely,
T_{offset}(t+Δ)=T_{offset}(t)+bΔ (8)
where c=0 in the polynomial fit of equation (1).

We now reconsider equations (2a)-(4a) treating the clock offset as a function of time. Consequently, the pseudo-range measurements are also a function of time. For clarity, we assume that the ranges remain essentially constant over the interval Δ. The pseudo-range measurements may be described as:
pr₁(t₁)=r₁+T_{offset}(t₁) (2b)
pr₂(t₂)=r₂+T_{offset}(t₂) (3b)
pr_{N}(t_{N})=r_{N}+T_{offset}(t_{N}) (4b)

In one embodiment, the user terminal 102 commences with an additional set of pseudo-range measurements at some time Δ after the initial set of measurements. These measurements may be described:
pr₁(t₁+Δ)=r₁+T_{offset}(t)+bΔ (2c)
pr₂(t₂+Δ)=r₂+T_{offset}(t₂)+bΔ (3c)
pr_{N}(t_{N}+Δ)=r_{N}+T_{offset}(t_{N})+bΔ (4c)

The user terminal 102 then projects all the pseudo-range measurements to some common point in time (common time instant) so that the effect of the first order term is effectively eliminated. For example, consider if some common reference time t₀ is used. Applying equations (2b-4b) and (2c-4c) it is straightforward to show that we can project the measurements to a common instant of time as follows:
pr₁(t₀)=pr₁(t₁)+[pr₁(t₁+Δ)−pr₁(t₁)](t₀−t₁)/Δ (2d)
pr₂(t₀)=pr₂(t₂)+[pr₂(t₂+Δ)−pr₂(t₂)](t₀−t₂)/Δ (3d)
pr_{N}(t₀)=pr_{N}(t_{N})+[pr_{N}(t_{N}+Δ)−pr_{N}(t_{N})](t₀−t_{N})/Δ (4d)

These projected pseudo-range measurements are communicated to the location server where they are used to solve the three unknowns x, y, and T_{offset}(t₀). Note that the projection in equations (2d-4d) is not precise, and second order terms are not accounted for since we assume c=0 in equation (1). However the resulting errors are not significant. One skilled in the art will recognize that second order and higher terms may be accounted for, if necessary, by making more than two pseudo-range measurements for each projection. Notice also that there are many other approaches to implementing this concept of projecting the pseudo-range measurements to the same instant of time. One approach, for example, is to implement a delay lock loop such as those disclosed in J. J. Spilker, Jr., Digital Communications by Satellite, Prentice-Hall, Englewood Cliffs, N.J., 1977, 1995 and B. W. Parkinson and J. J. Spilker, Jr., Global Positioning System-Theory and Application, Volume 1, AIAA, Washington, D.C. 1996, both incorporated by reference herein. A separate tracking loop can be dedicated to each DTV transmitter 106. These tracking loops effectively interpolate between pseudo-range measurements. The state of each of these tracking loops is sampled at the same instant of time.

In some implementations, user terminal 102 does not compute pseudo-ranges, but rather takes measurements of the signals that are sufficient to compute pseudo-range, such as a set of correlator outputs, and transmits these measurements to location server 110. Location server 110 then computes the pseudo-ranges based on the measurements, and computes the position based on the pseudo-ranges, as described above. The computation of correlator outputs sufficient to produce positioning information is discussed further, below.

Position Location Performed by User Terminal

In some implementations, the position of user terminal 102 is computed by user terminal 102. In this implementation, all of the necessary information is transmitted to user terminal 102. This information can be transmitted to user terminal by location server 110, base station 104, one or more TV transmitters 106, GPS satellites 120, or any combination thereof. User terminal 102 then measures the pseudo-ranges and solves the simultaneous equations as described above. This implementation is now described.

User terminal 102 receives the time offset between the local clock of each TV transmitter 106 and a reference clock. User terminal 102 also receives information describing the phase center of each TV transmitter 106 from a database 112.

User terminal 102 receives the tropospheric propagation velocity computed by location server 110. In some implementation, user terminal 102 receives weather information describing the air temperature, atmospheric pressure, and humidity in the vicinity of user terminal 102 from a weather server 114, and determines tropospheric propagation velocity from the weather information using conventional techniques.

User terminal 102 can also receive from base station 104 information which identifies the rough location of user terminal 102. For example, the information can identify a cell or cell sector within which a cellular telephone is located. This information may be used, for example, for ambiguity resolution.

User terminal 102 receives TV signals from one or more TV transmitters 106 and determines a pseudo-range between the user terminal 102 and each TV transmitter 106. User terminal 102 receives GPS signals from one or more GPS satellites 120 and almanac data describing Doppler shifts and pseudo-noise code numbers for the GPS satellites, as described below, and determines pseudo-ranges between the user terminal 102 and the GPS satellites 120. User terminal 102 then determines its position based on the pseudo-ranges, the locations of the TV transmitters 106, and the locations of the GPS satellites 120.

In any of these implementations, the position of user terminal 102 can be determined using a TV transmitter and the offset T computed during a previous position determination for that TV transmitter. The values of T can be stored or maintained according to conventional methods.

In, some implementations, base station 104 determines the clock offset of user terminal 102. Only two transmitters are required in these instances for position determination. Base station 104 transmits the clock offset T to location server 110, which then determines the position of user terminal 102 from the pseudo-range computed for each of the transmitters.

Receiver Signal Processing Architecture

The signal processing for both TV and GPS signals can be performed either using correlation of short samples of the received digitized signals or by using a delay-lock loop or time-gated delay lock loop. Such delay lock loop techniques are disclosed in commonly-owned copending U.S. Non-provisional patent application Ser. No. 10/054,262, “Time-Gated Delay Lock Loop Tracking Of Digital Television Signals,” by James J. Spilker and Matthew Rabinowitz, filed Jan. 22, 2002, the disclosure thereof incorporated by reference herein in its entirety. As described in greater detail below, this disclosure will consider the application of determining pseudo-ranges based on appropriately-applied correlation methods.

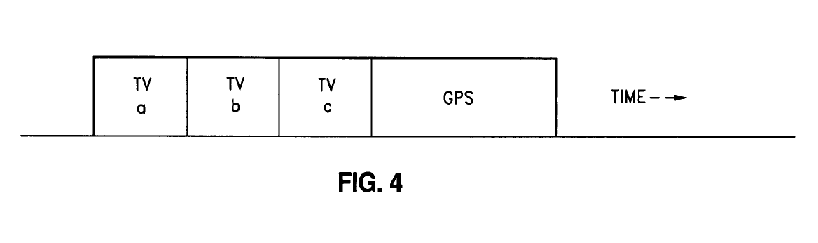

FIG. 4 shows a time-switching sequence for an integrated TV/GPS receiver in a user terminal according to some implementations. The receiver time sequences over the various signal sources changing the TV channel frequencies to examine three TV signals (TVa, TVb, and TVc) in this example and then switching to the GPS band to examine one or more GPS signals. Of course, when tuned to the GPS band, the receiver can correlate any of the GPS satellites and multiple GPS satellites concurrently.

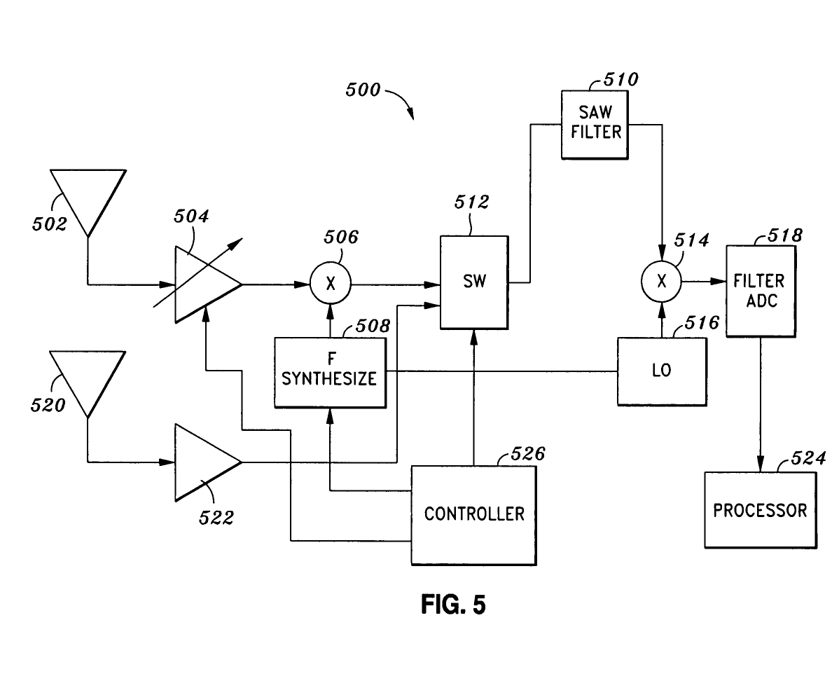

FIG. 5 shows a receiver 500 that may be implemented in a user terminal. The receiver is capable of processing both television signals and GPS signals for position determination according to some implementations. A TV antenna 502 receives the TV signals. In other implementations, the same antenna can be used for both the GPS and the TV signal. This antenna may be coupled to a tuning circuit (not shown) to form an antenna system in order to resonate at the different frequencies of the television signals or the GPS signals. Alternately, this antenna can have two feeds, one which outputs a signal in the GPS band and one which outputs a signal in the TV band, with a switch determining which feed outputs to the low noise amplifier (LNA) in the receiver front end. A low noise amplifier and RF filter 504 amplifies and filters the received TV signals. The RF filter is tunable over the required range for the set of TV channels that is selected. This could, for example, include the UHF channels in the range 450 MHz through 7 MHz. The low noise amplifier 504 includes an automatic gain control function. In one embodiment, a frequency converter includes a mixer 506, a local oscillator (not shown) and a frequency synthesizer 508. The mixer 506 combines the resulting signal with the output of a frequency synthesizer 508 to up-convert the signal to an IF frequency where a narrow bandwidth SAW filter 510 can be employed. In one embodiment, the local oscillator operates in conjunction with the frequency synthesizer 508. A switch 512 passes the TV signal to the SAW filter 510. In some embodiments, in order to make use of GPS the IF frequency is at or near to the GPS L1 frequency of 1575.42 MHz. Other implementations use the L2 frequency of 1227.6 MHz, which will shortly have a new civil signal, or the new L5 signal in the 1.1 GHz region. In still other implementations, a different IF frequency can be used and the GPS signal as well as the TV signal will initially be up-converted or down-converted prior to bandpass filtering.

In one embodiment, a frequency converter includes a mixer 514 and a local oscillator 516. The mixer 514 combines the filtered signal with the output of a local oscillator 516 to down-convert the filtered signal to a post-frequency converter signal at a convenient IF frequency. In another embodiment, the local oscillator 516 is driven by the frequency synthesizer 508. In one embodiment, the IF frequency is 44 MHz, a standard TV IF frequency. Filter/ADC 518 then filters and digitizes the signal. The signal can then be IF sampled at, for example, 27 Msps using a 10 bit ADC. The digitized signal is fed to a processor 524 for processing. A controller 526 controls filter/amplifier 504, frequency synthesizer 508, and switch 512.

Processor 524 includes, in one embodiment, a digital signal processor (DSP) for retiming and recovering the digitized received signal and using pertinent portions of the signal for time-offset and/or pseudo-range determination. In other embodiments, one or more general purpose microprocessors or ASICs may be used for this application. Exemplary algorithms and associated pseudo-code for execution in processor 524 is set forth below.

A GPS antenna 520, such as a patch antenna, receives the GPS signals. A low noise amplifier and RF filter 522 amplifies and filters the received GPS signals. Switch 512 passes the GPS signal to SAW filter 510. Mixer 514 combines the filtered signal with the output of a local oscillator 516 to down-convert the filtered signal to a convenient IF or baseband frequency. Filter/ADC 518 then filters and digitizes the signal. The signal can then be IF sampled at, for example, 27 Msps using a 10 bit ADC. GPS can be sampled at substantially lower sampling rates and with fewer bits without significantly affecting performance. The digitized signal is fed into a processing component 524 for digital processing. In accordance with the knowledge of one skilled in the art, it is clear that the processing component 524 may be a processor, a microprocessor, a DSP or may be implemented largely in hardware.

In one embodiment, the receiver front end comprises at least one low noise amplifier and RF filter 504, at least one mixer 506, a frequency synthesizer 508, at least one local oscillator 516, a filter 510, an Analog to Digital Converter (ADC) 518 and a controller 526. In some implementations, the entire RF section is fabricated as a single integrated circuit, with the possible exception of the SAW filter 510 (or similar high selectivity bandpass filter) and the processing component 524 which may be fabricated as one or more separate integrated circuits.

We will now explore some of the components of FIG. 5 in more detail. We begin with the digital processing section as represented by processor 524. In one embodiment of the invention, there is a second IF at a center frequency of 44 MHz, the signal is sampled at a rate of 27 MHz, and a coherent down-conversion architecture is used, where carrier acquisition is performed on the sampled signal. None of these assumptions are crucial to ideas discussed, as one skilled in the art will recognize.

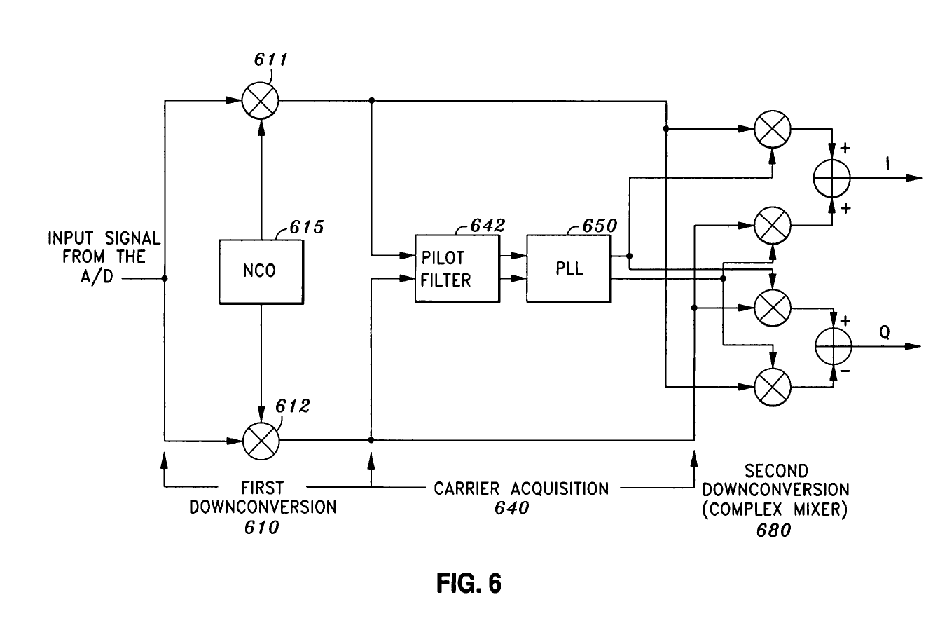

FIG. 6 illustrates a coherent down-converter which, in one implementation, takes a real valued signal output from the ADC, and generates a complex valued baseband signal. As noted above, part or all of this implementation may be performed by a DSP or other processing-based device, or it may be performed by dedicated hardware intermediary to the processor and ADC. The second IF signal has a spectrum that lies between [41, 47] MHz, which after undersampling at 27 MHz by the A/D converter, gets translated to a [7, 13] MHz band. A reversal of the spectrum may also be performed to place the pilot signal at the lower end of the spectrum, in the vicinity of 7 MHz. Due to the large offsets of the pilot frequency between various analog and digital channels, the coherent downconverter typically needs frequency aiding, i.e. an external algorithm supplies an estimate of the pilot frequency, accurate enough for it to lie within the tracking range of the PLL. In one embodiment, this information on the frequency offset of each channel is measured at the monitor unit and passed to the mobile device. One method for estimating the pilot frequency may be found in copending application “Pilot acquisition and local clock calibration with reduced MIPS,” which is incorporated by reference as if fully set forth herein.

In the embodiment of FIG. 6, the downconversion may be accomplished in two stages. The first stage (utilizing the first downconversion unit 610) includes mixing the real-valued input signal with quadrature outputs of a Numerically Controlled Oscillator (NCO), whose frequency is adjusted to lie 700 kHz below the estimated pilot frequency. The spectrum of the signal is translated such that the pilot signal lies at 700 kHz. The downconversion to 700 kHz prior to recovering the carrier enables us to design a single, fixed coefficient filter to extract the pilot signal. The pilot frequency output from the A/D varies over a range of several hundred kHz as we tune through different channels. Accordingly, in this embodiment, it is necessary to reduce the pilot frequency to a fixed value by correctly setting the frequency of the first downconversion 610.

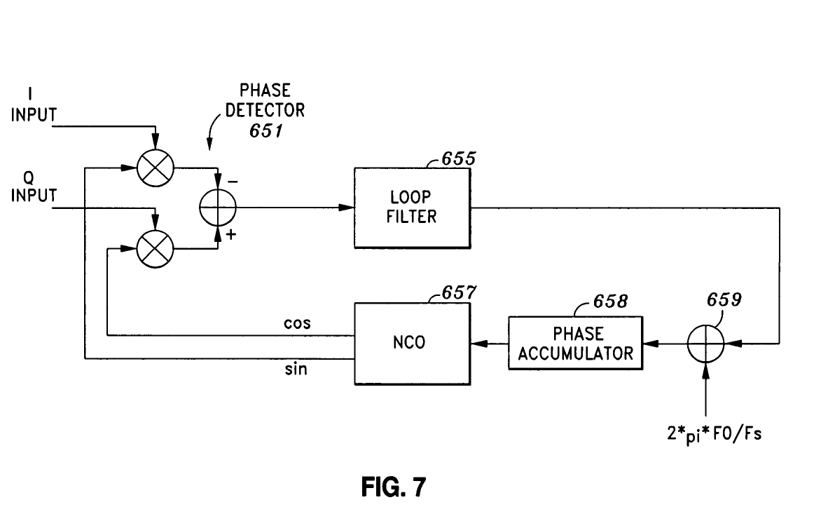

After the first downconversion 610, the signal is branched into two paths—namely through the carrier acquisition unit 640 and second downconversion unit 680. Carrier acquisition unit 640 (a.k.a. carrier recovery) consists of a narrow bandpass filter 642 and a phase-locked loop (PLL) 650 which is illustrated in FIG. 7. The purpose of the PLL 650 in this embodiment is to reproduce the vestigial sideband (VSB) carrier with the help of the pilot signal present in the received signal. As seen in FIG. 7, the PLL 650 includes a phase detector 651, loop filter 655 and an NCO 657. The NCO 657 is programmed to generate a 700 kHz signal. The phase detector is simply a complex mixer which multiplies the I/Q outputs of the filtered Pilot signal with I/Q outputs of the NCO 657. The resulting signal is passed through a loop filter, which is implemented in one embodiment as a second order Infinite Impulse Response (IIR) Filter. The loop filter coefficients are designed to satisfy closed loop stability, the desired tracking range and acceptable phase noise of the NCO. The output of the loop filter 655 may then be scaled by a constant (device 659) and added via phase accumulator 658 to the phase word of the numerically controlled oscillator (NCO), which determines the rate of the NCO, and maintains lock in the filtered pilot signal.

The second downconversion unit 680 includes a complex mixer which mixes the I-Q outputs of the first stage of downconversion with the I-Q outputs of the PLL 650. The resulting signal is converted to baseband and, in this embodiment, has a spectrum in the range [0, 6] MHz.

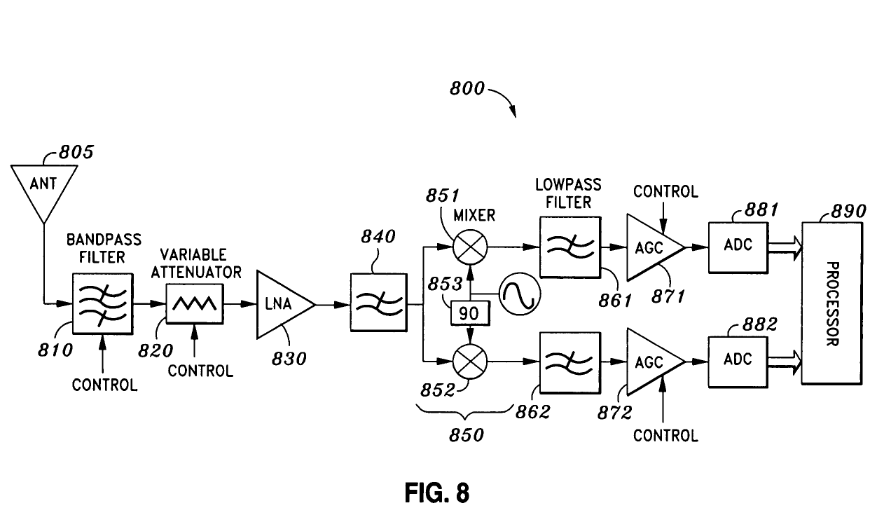

Many alternative techniques exist to implementing the signal processing, which do not change the fundamental idea of the invention. We will not explore in detail the alternative techniques that can be used for processing the GPS signals, since these techniques are well understood in the art. We will focus instead on alternative methods and architectures for processing the TV signals. One alternative is to convert the TV signal output from the SAW filter 510 to baseband instead of to some IF frequency. This approach would typically make use of an in-phase and a quadrature mixer, instead of a single mixer 514. Some of the issues associated with the conversion of an analog signal to baseband will now be discussed in the context of the direct down-conversion architecture of FIG. 8.

The receiver architecture 800 shown in FIG. 8 is well-suited to integrating the TV receiver component into an Application Specific Integrated Circuit (ASIC), although a variety of configurations may be contemplated. The tunable bandpass filter 810 removes unwanted interference signals so that the Low Noise Amplifier (LNA) 830 is not saturated, and inter-modulation products do not disrupt system performance. The tunable bandpass filter 810 has an adjustable passband which can be adjusted to select an instantaneous desired frequency band. The attenuator 820 at the front end is designed to improve the dynamic range of the circuit, by attenuating signals when the mobile device is close to a TV transmitter and receiving a very powerful signal. The LNA 830 amplifies the signal. The signal is then passed to an I/Q downconverter 850 which includes mixers 851, 852, a 90° phase shifter 853 and a local oscillator 854. The mathematics associated with the downconversion is analyzed below. The output of the I/Q downconverter 850 is an I component of the signal and a Q component of the signal. The Local Oscillator (LO) 854 signal driving the mixers 851, 852 and the 90° phase shifter 853 converts the signal down to baseband, or a very low Intermediate Frequency (IF) so that it can be filtered with low-pass filters 861, 862 that can be implemented on an Integrated Circuit (IC). The Automatic Gain Control (AGC) 871, 872 adjusts the magnitude of the signal so as to make better use of the available bits of the Analog to Digital Converter (ADC) 881, 882. The outputs of the ADCs 881, 882 constitute digitized I components and digitized Q components. In this embodiment, the outputs of the ADC 881, 882 are inputs to a processing component 890. In accordance with the knowledge of one skilled in the art, it is clear that the processing component 890 may be a processor, a microprocessor, a DSP or may be implemented largely or completely in hardware.

The receiver architecture 800 being described here is a typical for two reasons: Firstly, it does not require the use of an off-chip Surface Acoustic Wave (SAW) SAW filter which most TV receivers employ. Secondly, the receiver is designed to receive only Ultra-High Frequency (UHF) DTV channels, so that the full tuning range can be covered by a single Voltage-Controlled Oscillator (VCO). Of course, additional direct down-conversion paths can be added to receive VHF signals as well as UHF.

While the direct downconversion architecture may be difficult to implement for a data reception receiver, it is more straightforward to use this architecture for a navigation receiver because so much processing gain is available in the digital signal processing of a navigation receiver.

Software Receiver

Once the signal is received and appropriately digitized using one of the examples discussed above, many different approaches exist for correlating the receiver with the downconverted signal and extracting timing information. One approach which considerably mitigates the effects of multipath interference is to use a software algorithm to sample an entire autocorrelation function, rather than to use only early and late samples as in a standard DLL (Delay-locked loop) implemented in hardware. For the purpose of this disclosure, software can refer not only to code run on a general purpose processor, but also to code, whether programmable or firmware, that may be run on special-purpose processors such as DSPs or programmable cores.

Multipath effects can be mitigated by selecting the earliest correlation peak, which generally corresponds to the most direct path of the signal received from the TV transmitter to the user device. In the case that position can be computed with a brief delay, a simple approach is to use a software receiver, which samples a sequence of the down-converted signal, and then processes the sample in firmware on a DSP. We will first describe the correlation processing in the context of a non-coherent software receiver which does not acquire an incident pilot signal.

A nominal offset frequency for the downconverted sampled signal is assumed. If the signal is downconverted to baseband as with the discussion above, the nominal offset is 0 Hz. The process generates the complete autocorrelation function, R(τ), based on sampled signal Sₛₐₘₚ(t). Let Tₛ be the period of data sampled, ωᵢₙ be the nominal offset of the sampled incident signal, and let ω_{offset} be the largest possible offset frequency, due to Doppler shift and oscillator frequency drift. The process implements, in one embodiment, the pseudocode listed below.
Rₘₐₓ=0
Create a complex code signal
   S_{code}(t)=Cᵢ(t)+jC_{q}(t)
where Cᵢ represents a function describing the in-phase baseband signal and C_{q} is a function describing the quadrature baseband signal.
Compute F (s_{code})* where F is the Fourier transform operator, and * is the conjugate operator.
For ω=ωᵢₙ−ω_{offset} to ωᵢₙ+ω_{offset} step

$$Δω = \frac{π}{2 {T}_{s}}$$
Create a complex mixing signal
   sₘᵢₓ(t)=cos(ωt)+j sin(ωt)
Combine the incident signal s(t) and the mixing signal Sₘᵢₓ(t)
   s_{comb}(t)=sₛₐₘₚ(t)sₘᵢₓ(t)
Compute the correlation function
   R(τ)=F⁻¹{F(s_{code})*F(s_{comb})}
If max_{τ}|R(τ)|>Rₘₐₓ, Rₘₐₓ→max_{τ}|R_{(τ)|, R}ₛₜₒᵣₑ(τ)=R(τ)
Next ω

Upon exit from the process, Rₛₜₒᵣₑ(τ) will store the correlation between the incident sampled signal sₛₐₘₚ(t) and the complex code signal s_{code}(t). Rₛₜₒᵣₑ(τ) may be further refined by searching over smaller steps of ω. The initial step size for ω must be less then half the Nyquist rate.

$$\frac{2 π}{{T}_{s}} .$$

The time offset τ that produces the maximum correlation output is used as the pseudo-range. As one skilled in the art will recognize, the above pseudo-code can readily be translated into a generic or machine/circuit specific computer program or set of programs to perform the identified operations.

Thus, in one embodiment, a software receiver is employed which samples a sequence of the downconverted signal, and then processes the samples in firmware on a DSP, microprocessor, or similar processing circuit. A receiver implementation in accordance with an embodiment of the present invention will be described in the context of receiving and digitally processing an illustrative digital television signal. It should be understood, however, that the disclosed receiver has equal applicability to other types of television signals and standards, as discussed above. A digital television broadcast signal presents a suitable framework for describing an embodiment of the invention. Accordingly, certain characteristics of an exemplary digital signal are discussed below.

Digital Television Signal Characteristics

While the principles of the present invention are equally applicable to a wide variety of signal types as discussed in greater detail above, one illustrative embodiment uses information contained in a standard ATSC digital television signal to acquire synchronization codes and extract timing information. Accordingly, while the invention is not limited to such an embodiment, we present it here for illustrative purposes as a foundational example of the capabilities of the various aspects of the present invention.

The advancement of the state of the art presently allows the transmission of digital television (DTV) in the same six (6) MHz bandwidth currently used by NTSC. Generally, digital transmission provides superior video and audio reception. In one implementation involving the American Television Standard Committee (ATSC), digital television relies on a signaling technique known as vestigial sideband (“VSB”), which has been developed for terrestrial and cable television broadcasting in the United States. The digital VSB transmission system uses three supplementary signals for synchronization. First, a pilot signal having a relatively small amplitude is used for acquisition of the carrier signal. Second, a data segment sync sequence is employed for synchronizing the frequency and phase of the data clock at the receiver. Third, a data frame sync sequence is used for data framing and equalizer training. The present symbol rate of the ATSC signal is fₛ=10.762237 MHz, which is derived from a 27.000000 MHz clock.

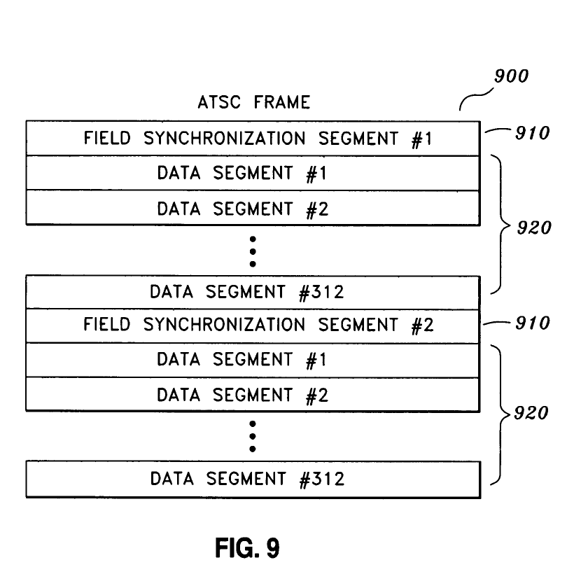

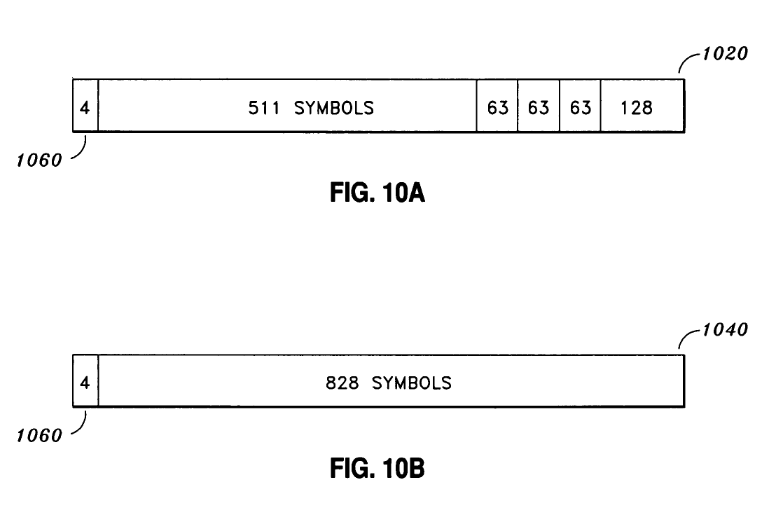

A representation of an exemplary ATSC frame 900 is shown in FIG. 9. The ATSC frame 900 in this configuration includes a total of 626 segments (312×2 data segments+2 field synchronization segments), with each of two field synchronization segments 910 respectively followed by 312 data segments 920. A field synchronization segment 1020 is shown in FIG. 10A. The field synchronization segment 1020 is used to indicate the commencement of a series of 312 ensuing data segments. An exemplary data segment 1040 is shown in FIG. 10B. Each data segment 1040 and field synchronization segment 1020 begins with a four-symbol synchronization code 1060. As will be seen, for the ATSC DTV 8-VSB standard, it is this synchronization code 1060 upon which the software uses in one embodiment to establish a correlation peak for the purposes of extracting timing information for position location.

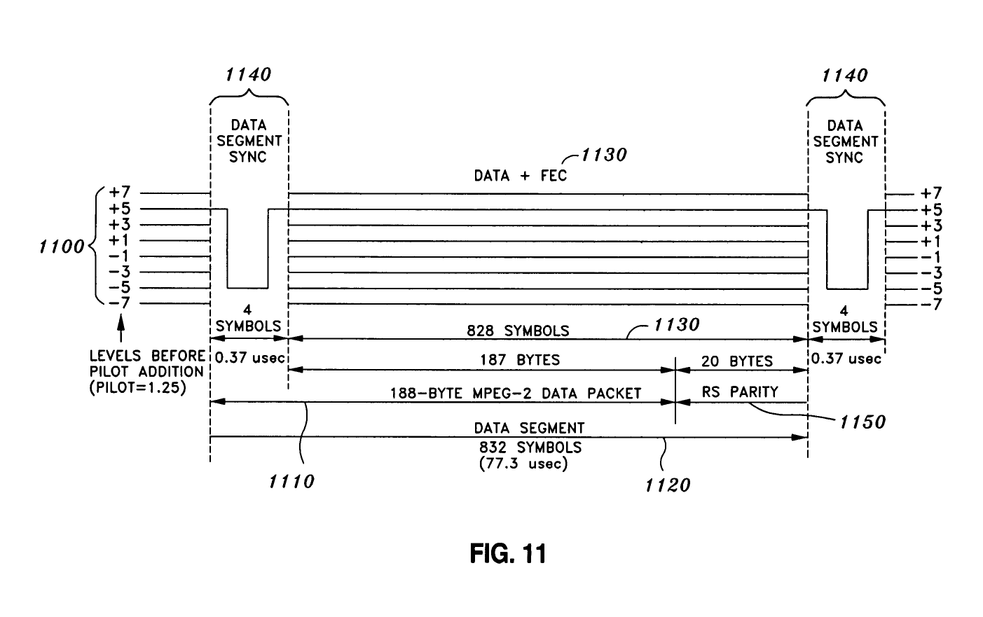

FIG. 11 shows an exemplary format of an 8-VSB signal used in digital television transmissions. The frame in the implementation shown is in coded 8-VSB baseband data signal format. For clarity, the horizontal direction of the figure represents time, and the vertical direction represents amplitude or relative signal power. For the purposes of this disclosure, it should be noted that different digital and analog formats exist and can be implemented without departing from the spirit or scope of the present invention. In the 8-VSB signal format shown in FIG. 11, eight discrete data levels 1100 (−7, −5, −3, −1, +1, +3, +5, +7) 1100 are present. Because the modulation scheme is 8-ary VSB in this configuration, each symbol carries 3 bits of coded data, thereby accounting for the eight data levels per symbol. These levels are shown prior to the addition of the low-level pilot signal. Generally, in the digital transmission system, various other modes may be used in lieu of the depicted format, including VSB modes (e.g., 2, 4, 8, 8-trellis, 16, etc.). The total data rate of the transmitted signal typically depends upon the number of discrete signal levels, whether which coding is used, and other criteria. Presently, 19.3 Mbit/second coded 8-VSB has been selected for terrestrial DTV broadcasting, while 38.6 Mbit/sec 16-VSB has been selected for carrying two 19.3 Mbit/sec terrestrial digital broadcast signals in one 6 MHz channel on cable systems. The specific characteristics of the signal may vary without departing from the scope of the invention.

As noted above, the data signal in FIG. 9 is divided into equal length packets 920 called segments. The segment is compatible with the 188-byte MPEG-2 data packet standard (1110) (FIG. 11). Each segment includes 832 symbols of total time duration 77.3 μS, as shown by 1120 in FIG. 11. Of these 832 symbols, 828 symbols (1130) may be used for data transmission and error recovery. The remaining 4-symbols in this modulation scheme constitute a binary data segment synchronizing signal 1140 referred to herein as SYNC, or more simply the synchronization code for the illustrated digital television signal. In addition, twenty Reed-Solomon (RS) parity bytes (1150) for every data packet add redundancy in this implementation for forward error correction (FEC). Each frame includes a total of 626 segments, each segment containing 832 symbols for a total of 520,832 symbols per frame. Because the modulation scheme is 8-ary VSB in this configuration, each symbol carries 3 bits of coded data as noted above.

An in-phase pilot signal is generated in this modulation scheme by adding a DC value to the baseband signal. The pilot signal is at a constant RF level, at about 11.3 to 12 dB below the 8-VSB data modulated signal components. The pilot signal in this implementation aids in coherent demodulation independent of data, reduces receiver implementation loss, and provides reliable carrier recovery down to very low signal-to-noise ratios. Following modulation of the baseband signal with a high frequency carrier, the pilot signal exists as an in-phase signal.

The in-phase pulse of the 8-VSB signal, constructed by filtering, has a raised-cosine characteristic. To create a VSB signal from the in-phase pulse, the signal is filtered so that only a small portion of the lower sideband remains.

The four-symbol binary SYNC 1140 in this embodiment is repetitive, fixed, and binary. In light of the random nature of the data, the repetitive SYNC signal 1140 may be readily identified. The SYNC signal 1140 may be used to assist in recovery of the clock signal and to allow for correct identification and synchronization of a data segment 1120. The repetitive nature of the SYNC allows receivers to determine the location of the segment intervals in the received signal and, as will be seen, enables the receiver to determine user location based on correlation methods.

Ideal Receiver Operation

For the purposes of understanding the elements of the various embodiments herein, the ideal operation of a mobile receiver is first described and certain key operations are discussed. Thereafter, a description of the basic operations of various embodiments of the mobile receiver is presented. While the discussion below contemplates the use and reception of an ATSC-based digital television signal, it will be appreciated that different types of television broadcast signals may be used without departing from the scope of the invention. In certain embodiments, as will be seen, the receiver rearranges the order of the basic operations and provides for superior software approaches using coherent accumulation of phase-corrected signal segments.

In certain embodiments, the signal is received, filtered, amplified and digitized by analog front end circuitry, where it is then passed to a processor (such as a microprocessor or DSP) where specific code is executed and operations are performed on the digitized data. Below, various such methods are presented.

The ideal ATSC digital TV signal at the mobile receiver has the following form:
S(t)=[(d(t)+A)+jd*(t)]e^{jω}^{ₚ}^{t+φ}
where d(t) represents the amplitude data signal on the inphase arm, and d*(t) represents the Hilbert Transform of d(t) on the quadrature arm relative to the pilot frequency ωₚ. Here we use j=\sqrt{−1} as the complex number in these equations.

The three key parameters in the ideal received signal S(t) are the pilot frequency ωₚ, the carrier phase φ, and the signal frame times. In practical operation, these parameters are unknown and may be estimated at the mobile receiver. The pilot frequency can be readily ascertained in accordance with principles discussed in this disclosure. The receiver as disclosed herein may accurately estimate these frame times embedded in the received signal, which then may translate to pseudo-range measurements for purposes of determining position of the mobile receiver in conjunction with other signal measurements (e.g., from GPS transmitters or other television broadcast stations). In addition, a low-level pilot signal having amplitude A is employed for carrier acquisition as noted above.

For the purposes of assessing ideal receiver operation, it is assumed here that the above-described digital TV signal is received without distortion due to noise, Doppler shifts, or multipath interference in the communication channel from the TV transmitter to the mobile receiver.

Down-Conversion to Baseband

For ideal operations, the receiver may be assumed to have a perfect estimate of the pilot frequency cop Various methods may be used in practice to determine the pilot frequency at the receiver, such as those disclosed in copending application “Pilot acquisition and local clock calibration with reduced MIPS,” by the same inventors and incorporated by reference herein. With the assumption of a perfect estimate in ideal operation, the received broadband signal may be down-converted to its corresponding baseband signal D(t) using the relationship:
D(t)=S(t)e^{-jω}^{ₚ}^{t}=[(d(t)+A)+jd*(t)]e^{jφ}
In cases where this procedure is performed in hardware on the receiver, a conventional multiplier or mixer circuit may be used to perform the down-conversion step.

Next the following trigonometric property is employed:
e^{jφ}=cos φ+j sin φ (9)
Using the above relationship (9), D(t) can now be represented as follows:

$$\begin{matrix}D ( t ) = [ ( d ( t ) + A ) + {jd}^{*} ( t ) ] [ cos ϕ + j sin ϕ ] & ( 10 a ) \\ = ( d ( t ) + A ) cos ϕ + j ( d ( t ) + A ) sin ϕ + {jd}^{*} ( t ) cos ϕ - {d}^{*} ( t ) sin ϕ & ( 10 b )\end{matrix}$$

Using equations (10a) and (10b) above, the real and imaginary components, sᵢ(t) and s_{q}(t) respectively, of the complex baseband signal D(t) are determined to be
Re{D(t)}=s₁(t)=(d(t)+A)cos φ−d*(t)sin φ (11)
and
Im{D(t)}=s_{q}(t)=(d(t)+A)sin φ+d*(t)cos φ (12)

These equations establish that multiplying the broadband signal S(t) by the ideal e^{-jω}^{ₚ}^{t} produces these two ideal forms of the received baseband inphase signal sᵢ(t) and quadrature signal s_{q}(t) relative to the pilot carrier frequency.

Correlation with Segment Sync Bits

As discussed above in connection with FIGS. 9 and 11, an ATSC signal may be divided into equal length MPEG-2 packets called segments, where each segment includes 832 symbols of total time duration T=77.3 μS. Each such segment begins with four fixed, binary symbols for segment synchronization. Accordingly, during every T=77.3 μS interval there exist four known segment bits. The data segment synchronization code (SYNC) may be used for synchronizing the data clock in both frequency and phase. In addition, using correlation methods, a mobile receiver may accurately estimate the time of arrival of these segment sync bits. Once this time-of-arrival information is calculated, the receiver can ultimately estimate (or provide the necessary information for a location server or other device to estimate) its position relative to the broadcasting transmission system. Accordingly, a description of an exemplary correlation method using the data segment SYNC according to one embodiment is set forth below.

In this example, h(t) represents the ideal four-bit segment SYNC for the time interval [0, T₀] where

$${T}_{0} = \frac{4 T}{832} = 0.37 μ S$$

Consequently, in the first segment time interval [0, T] using an ATSC standard digital television signal, the data signal d(t) has the following form:
d(t)=h(t−τ) for τ≦t≦τ+T₀
where the quantity τ represents the unknown beginning time of the occurrence of the segment sync bits in this first segment interval of the received signal. Stated differently, for values of t between τ and τ+T₀ only, the data signal d(t) is equal to the segment sync function h(t) delayed by τ (namely h(t−τ)). It will be appreciated that determination of this value τ using correlation methods enables a receiver to determine pseudo-ranges from transmitting broadcast antennas, and ultimately for facilitating the calculation of position location.

It should be noted that the quantity τ represents a time delay relative to a time reference (e.g., t′ᵤ) perceived by the receiving station, rather than the “true time” of the signal (e.g., tᵤ) actually transmitted from the broadcasting station. This distinction arises from the fact that the user device invariably does not have a perfectly synchronized clock. (Likewise, the transmitter has an imperfect clock and does not have precise knowledge of true time.) The user's clock is consequently offset from the true time by some time offset. The pseudo-range measurement computed by the receiving device constitutes the time from the start of sampling by the receiver to the instant when the burst of the synchronization code arrives at the receiver multiplied by the speed of light. A number of conventional mathematical techniques may be used for taking the relative imperfections of the transmitter and receiver clocks into consideration and calculating positioning information based on these considerations. Certain of these techniques are discussed above in connection with FIG. 1.

To estimate the quantity τ, correlation methods may be used. In general, the correlation of a signal a(t) with a reference waveform b(t) may be defined as

$${C}_{ab} ( t ) = {\int }_{- ∞}^{∞} a ( α ) b ( α - t ) ⅆ α \qquad ( 13 )$$

Using equation (13), the mobile receiver may compute the following complex correlation function:

$$C ( t ; 1 ) = {\int }_{0}^{T} D ( α ) h ( α - t ) ⅆ α \qquad ( 14 )$$

Equation (14) represents the correlation of the complex baseband signal D(t) with the previously-defined reference waveform h(t). The numeral 1 on the left hand side of the equation signifies that, for this example, the first segment interval of the received signal is being correlated with reference waveform h(t). From equation (14), it is evident that a mathematical correlation can be conceptually viewed as a measure of the similarity between two signals. The real and imaginary components of equation (14) may be computed:

$$\begin{matrix}Re \{ C ( t ; 1 ) \} = {\int }_{0}^{T} {s}_{i} ( α ) h ( α - t ) ⅆ α \\ and & ( 15 ) \\ Im \{ C ( t ; 1 ) \} = {\int }_{0}^{T} {s}_{q} ( α ) h ( α - t ) ⅆ α & ( 16 )\end{matrix}$$

Inserting the value of sᵢ(t) from equation (11) into equation (15) and ignoring certain terms of relatively negligible magnitude when compared to the data portion of the signal (e.g., A→0), the real component of equation (14) becomes

$$\begin{matrix}Re \{ C ( t ; 1 ) \} = {\int }_{0}^{T} [ d ( α ) cos ϕ - {d}^{*} ( α ) sin ϕ ] h ( α - t ) ⅆ α \\ = {\int }_{0}^{T} d ( α ) h ( α - t ) cos ϕ ⅆ α - \\ {\int }_{0}^{T} {d}^{*} ( α ) sin ϕ h ( α - t ) ⅆ α\end{matrix} \qquad ( 17 )$$

Similarly, inserting the value of s_{q}(t) from equation (12) into equation (16) and making the same assumptions as were made with respect to equation (15), the imaginary component of equation (14) becomes

$$\begin{matrix}Im \{ C ( t ; 1 ) \} = {\int }_{0}^{T} [ d ( α ) sin ϕ + {d}^{*} ( t ) cos ϕ ] h ( α - t ) ⅆ α \\ = {\int }_{0}^{T} d ( α ) sin ϕ h ( α - t ) ⅆ α + \\ {\int }_{0}^{T} {d}^{*} ( t ) cos ϕ h ( α - t ) ⅆ α\end{matrix} \qquad ( 18 )$$

For the next step in computing the correlation values in equations (17) and (18), it should be recognized that when t is in the interval [τ−T₀, τ+T₀], then
d(α)=h(α)
d*(α)=h*(α)
Substituting d(α) for h(α) and d*(α) for h*(α) into equation (17) yields

$$Re \{ C ( t ; 1 ) \} = {\int }_{0}^{T} h ( α ) h ( α - t ) cos ϕ ⅆ α - {\int }_{0}^{T} {h}^{*} ( α ) h ( α - t ) sin ϕ ⅆ α \qquad ( 19 )$$

Making the same substitutions into equation (18) yields

$$Im \{ C ( t ; 1 ) \} = {\int }_{0}^{T} h ( α ) h ( α - t ) sin ϕ ⅆ α + {\int }_{0}^{T} {h}^{*} ( α ) h ( α - t ) cos ϕ ⅆ α \qquad ( 20 )$$

The first component on the right side of equation (19) is the correlation of the waveform h(t) with a time-delayed version of itself, also known as the autocorrelation of a waveform. The second component on the right side of equation (19) represents the correlation of the Hilbert transform h*(t) with a time-delayed version of h(t). Both autocorrelations are multiplied by a trigonometric representation of the phase angle φ.

To further simplify equations (19) and (20), the following notations can be used:

$$\begin{matrix}{C}_{aa} ( t ) = {\int }_{- ∞}^{∞} h ( α ) h ( α - t ) ⅆ α \\ and & ( 21 ) \\ {C}_{{a}^{*} a} ( t ) = {\int }_{- ∞}^{∞} {h}^{*} ( α ) h ( α - t ) ⅆ α & ( 22 )\end{matrix}$$

Using the notations in equations (21) and (22), and observing the mathematical property that C_{a*a}(t)=C*ₐₐ(t), the inphase and quadrature correlation outputs in equations (19) and (20) can now be represented for t=t=t−τ as follows:
Re{C(t;1)}=Rₕₕ(t−τ) cos φ−R*ₕₕ(t−τ)sin φ (23)
and
Im{C(t;1)}=Rₕₕ(t−τ) sin φ+R*ₕₕ(t−τ) cos φ (24)

Accordingly, as is evident from equations (23) and (24), the beginning time τ of the occurrence of the segment sync bits can be determined through autocorrelations of the segment sync function h(t) (and its Hilbert transform), multiplied by various trigonometric representations of the television phase angle φ.

Coherent Accumulation of Correlation

In the previous section the correlation outputs for the inphase and quadrature phase outputs of an ideal digital television signal were computed for time 0 through time T. In this embodiment, the correlation method is extended to include the computation of correlation outputs for a TV signal received over N segment times with the total time interval [0, NT]. In such an implementation, the received signal may be viewed as N separate received signal waveforms, where each such waveform is defined over the same time interval [0,T]. The accumulation of N complex signals can be represented as S(t+nT) for 0≦t≦T for n=0, 1, 2 . . . , N−1. Each of these signals covers one segment time interval and consequently includes the segment sync bits in the same unknown location in the time interval [0, T].

One objective of coherent accumulation in this implementation is to improve the mobile receiver's ability to estimate the commencement of segment syncs in the received signal. Coherent accumulation is particularly useful given the normally noisy channels and non-ideal conditions over which digital signals traverse. The accumulated inphase and quadrature correlator outputs form the basis for estimating pseudo-ranges and ultimately, the position of the mobile receiver.

Given the assumptions above, the resulting accumulated complex correlation can be represented in one implementation as follows:

$$C ( t ; N ) = {\sum }_{n = 0}^{N - 1} {\int }_{0}^{T} D ( α + nT ) h ( α - t ) ⅆ α \qquad ( 25 )$$

Substituting the television signal representation S(t+nT) for the data signal in equation (14) and down-converting the signal to baseband format yields the following alternative representation of the accumulated complex correlation:

$$C ( t ; N ) = {\sum }_{n = 0}^{N - 1} {\int }_{0}^{T} S ( α + nT ) {ⅇ}^{- j {ω}_{p} ( α + nT )} h ( α - t ) ⅆ α \qquad ( 26 )$$

Equation (26) is useful for estimating the leading edge components of the digital television signal. The accumulated correlation computed in equation (26) does not, however, presume the existence of multipath components. In normal environments, multipath components exist at the receiver that may have an arbitrary phase relative to one another. Accordingly, in certain embodiments, the mobile receiver takes multipath components into account by cross-correlating both the inphase and quadrature baseband signals with the same reference waveform h(t). (An illustration of this cross-correlation is set forth subsequently in this disclosure.) Multipath interference can be accounted for by selecting the earliest and largest correlation peak. The general complex correlation output in equation (26) may be used to estimate the leading edge multipath component of the received digital television signal.

Changing Order of Operations

In one embodiment of the present invention, the order of operations leading to the computation of the complex correlation output C(t;N) may be modified. Changing the order of operations has numerous advantages, including, for example, significantly reducing the computational requirements of the mobile receiver while quickly and effectively facilitating an accurate determination of position location. In certain embodiments, as a result of changing the order of operations at the mobile receiver, principal portions of the receiver functionality may be implemented in software or firmware. In those embodiments, the computational requirements and hence the corresponding burden on the processor(s) and memory may be dramatically reduced. These advantages, while universally applicable, are particularly useful for sustaining high position determination performance in mobile devices having limited computational power and memory capacity.

In another embodiment, a method and apparatus for coherent accumulation of IF (Intermediate Frequency) signal segments is disclosed. Using the disclosed method and apparatus may permit a software implementation of the mobile receiver to perform positioning determination computations in real time.

In certain embodiments, the order of operations for receiving terrestrial broadcasts and calculating pseudo-ranges for receiver position location is altered as noted above to encompass the following steps:
(i) Estimation of Segment Phase Change
(ii) Accumulation of Segment Intervals
(iii) Down-Conversion to Baseband
(iv) Complex Correlation

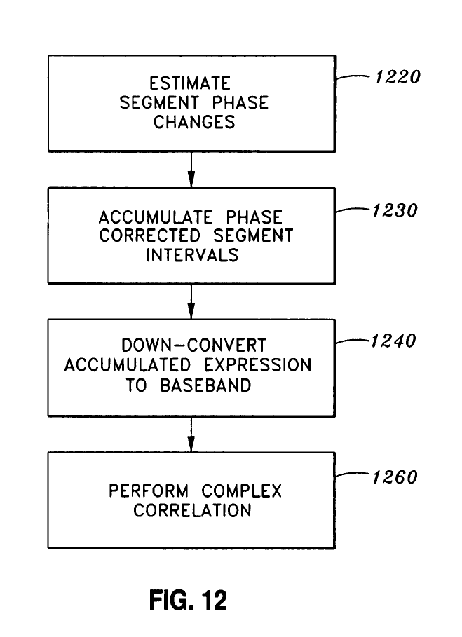

These steps are detailed below in the context of an exemplary configuration of the mobile receiver. The steps may be performed in software or firmware by a processing unit such as a microprocessor, DSP, or the like. FIG. 12 shows a flow diagram of an algorithm for computing pseudo-ranges in accordance with an embodiment of the invention. The steps listed above, among other advantages, can cut considerable computational overhead ordinarily associated with the correlation process by performing, in some embodiments, a complex correlation over an accumulated set of phase-adjusted signal intervals, in contrast to the requirement of correlating each independent segment interval with the reference waveform, the latter approach of which can inject considerable computation complexity into the process for determining τ for a given television waveform.

1. Estimation of Segment Phase Change

Generally, in non-ideal operations, the mobile receiver may not have exact knowledge of the pilot carrier frequency. As discussed below, the present invention provides a method for rapid acquisition by the processor of this pilot frequency. The receiver also may have no a priori knowledge of the phase term φ in each received segment. Referring to FIG. 12, the phase may be estimated at the receiver by estimating the phase terms φₙ for each of the N segment intervals referenced above, where n=0, 1, 2, . . . N−1 (step 1220). Further, as illustrated in greater detail below, each of these estimates at the receiver may be offset by the same constant without causing degradation during the calculations of the coherent accumulation. In particular, while a fixed phase offset for all segments may change the phase relationship of the final accumulated inphase and quadrature phase terms, the offset does not impact the coherent accumulation computation itself.

In one embodiment, in the n^{th} interval of T seconds the unknown received phase term φₙ can be calculated as follows:

$${ⅇ}^{j {ϕ}_{n}} = \frac{{\int }_{0}^{T} S ( t + nT ) {ⅇ}^{- j ω ( t + nT )} ⅆ t}{\vert {\int }_{0}^{T} S ( t + nT ) {ⅇ}^{- j ω ( t + nT )} ⅆ t \vert} \qquad ( 20 )$$

Equation (20) is accurate to the degree that the signal terms satisfy the following equations (21) and (22) below, relative to the pilot term

$${\int }_{0}^{T} A ⅆ t = AT .$$

$$\begin{matrix}{\int }_{0}^{T} d ( t + nT ) ⅆ t ≅ 0 & ( 21 ) \\ {\int }_{0}^{T} {d}^{*} ( t + nT ) ⅆ t ≅ 0 & ( 22 )\end{matrix}$$

Equations (21) and (22) may be considered reliable estimates in part because the baseband data in a digital television signal has zero mean, given that all of the data levels (e.g., 2, 4, 8, 16) are equiprobable. Thus, equation (20) may be used in this instance as a reasonable approximation of the segment phase changes for each value of n.

In addition, the phase estimates for each segment interval (equation (20)) may be robust and relatively insensitive to the actual proximity of the receiver's estimated pilot frequency ω to the true pilot frequency ωₚ. As an illustration of this insensitivity, assume that only the pilot signal is received so that S(t)=Ae^{jω}^{ₚ}^{t+φ}. Using this assumption, down-converting the signal to baseband using the receiver's local pilot frequency estimate ω, and integrating the expression over the first segment interval produces the following expression:

$${\int }_{0}^{T} S ( t ) {ⅇ}^{- j ω t} ⅆ t = {\int }_{0}^{T} A {ⅇ}^{j {ω}_{p} t + ϕ} {ⅇ}^{- j ω t} ⅆ t = ( A {\int }_{0}^{T} {ⅇ}^{j ( {ω}_{p} - ω ) t} ⅆ t ) {ⅇ}^{j ϕ} \qquad ( 23 )$$

The right hand side of equation (23) represents a complex constant multiplied by the phase term e^{jφ}. This expression may be considered, for illustrative purposes, a phase estimation “signal-to-noise ratio.” Equation (23) can also be observed that as long as the parameters in the complex expression

$$E = A {\int }_{0}^{T} {ⅇ}^{j ( {ω}_{p} - ω ) t} ⅆ t$$

remain relatively constant for each of the segment intervals, this expression results in a constant phase shift in the final accumulation of the IF signal segments. Stated differently, this phase estimation is relatively insensitive to small differences in ωₚ−ω. Accordingly, equation (20) may be used with reasonable precision to compute changes in signal phase for each interval and the relatively constant phase offset will not affect the overall coherent accumulation calculation. An appropriate software-executable instruction or instructions can enable the determination of phase offset as governed by equation (20).

An assumption can also be made with reasonable accuracy that the phase term (p as estimated in equation (20) changes relatively slowly in each segment. It follows that the complex term E set forth above may be assumed to represent the same constant in each segment interval. As such, in this embodiment, only the pilot tone phases need to be estimated in each segment interval.

The pilot signal may in many embodiments be approximately 12 dB below the data modulated signal. However, integrating over the 832 symbols of any T second segment interval in this configuration produces an integrated pilot term that is approximately 18 dB larger than the T second averaged signal terms.

In light of the above conclusions, and given any T second segment interval, the mobile receiver may obtain a phase estimate by integrating the inphase and quadrature baseband signals. A more general estimate of the phase may be provided by the following smoothing filter expression:
\hat{φ}ₙ=ρφₙ+(1−ρ)\hat{φ}ₙ₋₁ (24)
where φₙ is given above for n=0, 1, 2, . . . , N−1 with \hat{φ}₀=φ₀, and ρ represents a weighting parameter dependent upon the rate of change of the phase. There are many other means of estimating the phase changes that can be applied.

In other implementations, the carrier phase of an ATSC television signal may be estimated by using a matched input filter having a designated transfer function and applying the input of the signal to produce the desired output signal.
Let s(t)=mᵢ(t) cos(ωₚt+φ)+m_{q}(t) sin(ωₚt+φ) (24a)
where the inphase and quadrature phase components are represented as
mᵢ(t)=A+h(t)+r(t) and (24b)
m_{q}(t)=h*(t)+r*(t). (24c)

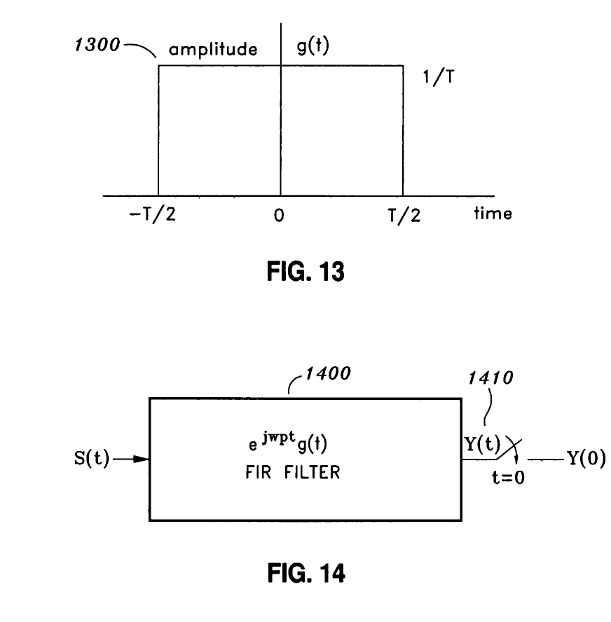

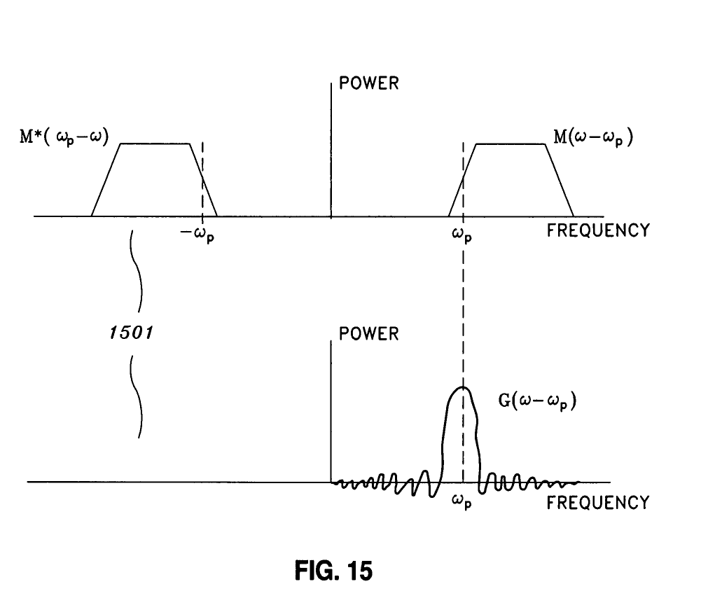

Here, h(t) represents the modulating signal attributable to the 4-symbol segment synchronization signal, and r(t) represents the modulating signal attributable to the data symbols (828 per segment). As before, the quantity A represents the pilot tone amplitude, and h*(t) and r*(t) represent the Hilbert transforms of h(t) and r(t), respectively. The carrier phase at time t=0 can be estimated as follows. Let g(t) represent a rectangular pulse 1300 as shown in FIG. 13. The pulse g(t) has a duration of T seconds and an amplitude of 1/T, and is centered at t=0. Thus, the pulse g(t) extends from −T/2 to T/2 seconds. Here, T is the period of the segment synchronization signal. Next, a Finite Impulse Response (FIR) filter 1400 may be used, as shown in FIG. 14. The impulse response of the filter 1400 is set to e^{jω}^{ₚ}^{t}g(t). The user device may filter the television signal s(t) using the FIR filter 1400, and the output y(t) of the filter is sampled at t=0 to produce Y(0), as illustrated by switch 1410. As demonstrated below, the estimated value of φ using this technique represents the angle formed by the complex value Y(0): namely, Y(0)=|Y(0)|e^{jφ}.

Using equations (24a), (24b), and 24(c), the expressions for g(t) and Y(t) from FIGS. 14 and 14, the following relationship can be derived:

$$Y ( 0 ) \approx \frac{1}{2} {ⅇ}^{j ϕ} [ \frac{1}{T} {\int }_{- T / 2}^{T / 2} ( A + h ( t ) + r ( t ) - {jh}^{*} ( t ) - {jr}^{*} ( t ) ⅆ t ] \qquad ( 24 d )$$

Equation (24d) may be determined as follows. The quantity m(t) is assumed to be the received baseband equivalent of the television signal s(t). Specifically, m(t)=mᵢ(t)−jm_{q}(t) in the time domain, or M(ω) in the frequency domain.

The following useful property can be mathematically verified:

$$s ( t ) = \frac{1}{2} [ m ( t ) {ⅇ}^{j ( {ω}_{p} t + ϕ )} + {m}^{*} ( t ) {ⅇ}^{- j ( {ω}_{p} t + ϕ )} ] \qquad ( 24 d1 )$$

Equation (24d1) can be rewritten, using a conventional Fourier transform, in the frequency domain:

$$S ( ω ) = \frac{1}{2} [ {ⅇ}^{j ϕ} M ( ω - {ω}_{p} ) + {ⅇ}^{- j ϕ} {M}^{*} ( {ω}_{p} - ω ) ] \qquad ( 24 d2 )$$

Additionally, g(t) can be expressed in the frequency domain as

$$G ( ω ) = sin c ( \frac{ω T}{2 π} )$$

so that the impulse response function e^{jω}^{ₚ}^{t}g(t) can be written as

$$G ( ω - {ω}_{p} ) = sin c ( \frac{( ω - {ω}_{p} ) T}{2 π} )$$

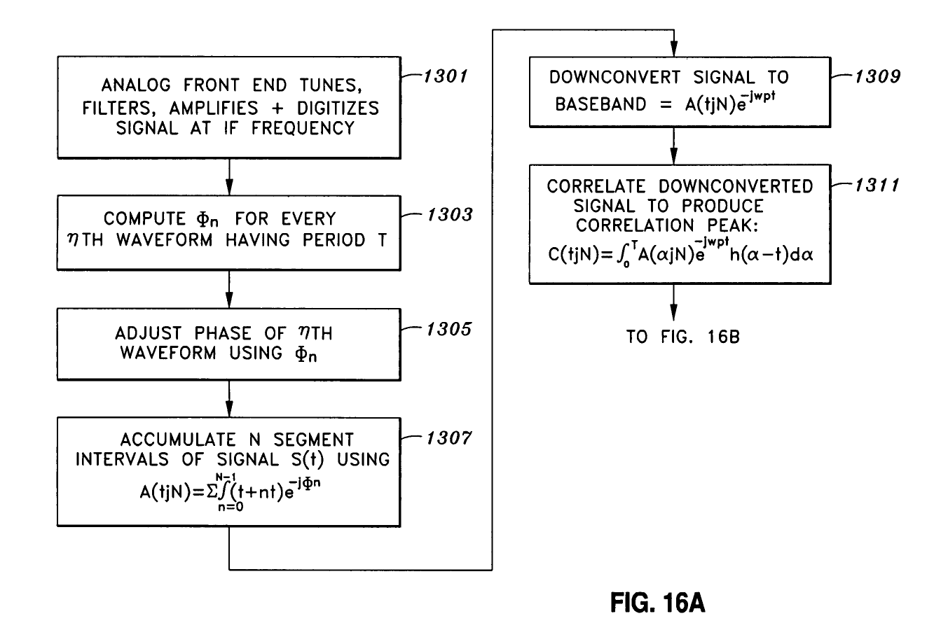

Corresponding graphical representations of the respective frequency responses of M, M* and G are shown in FIG. 15. M(ω−ωₚ) and M*(ωₚ−ω) both contain a relatively constant power level over most of their spectra and contain pilot frequencies on one edge. In contrast, the impulse response function G(ω−ωₚ) has a peak which is centered at ωₚ, and a similar peak is not present at −ωₚ. Over the interval at issue, the television signal is input into the filter such that the resulting output can be written in the frequency domain as

$$Y ( 0 ) = \frac{1}{2 π} {\int }_{- ∞}^{∞} S ( ω ) G ( ω - {ω}_{p} ) ⅆ ω \qquad ( 24 d3 )$$

Substituting the value of S(ω) from equation (24d2) into equation (24d3) yields the resulting expression

$$Y ( 0 ) = \frac{1}{2} {ⅇ}^{j ϕ} [ \frac{1}{2 π} ] {\int }_{- ∞}^{∞} M ( ω - {ω}_{P} ) G ( ω - {ω}_{P} ) ⅆ ω + \frac{1}{2} {ⅇ}^{{ω}_{p}} [ \frac{1}{2 π} ] {\int }_{- ∞}^{∞} {M}^{*} ( ω - {ω}_{P} ) G ( ω - {ω}_{P} ) ⅆ ω \qquad ( 24 d4 )$$

Referring back to FIG. 15, it can be concluded that the second integral in equation (24d4) is negligible, provided that cop is sufficiently large relative to the amplitude of the transfer function 1/T. More specifically, as the left hand side 1501 of FIG. 15 demonstrates, M*(ωₚ−ω)×G(ω−ωₚ)→0 for ωₚ>>1/T. In light of this simplifying assumption, the integral based on the Hilbert transform M* can be disregarded and the remaining first integral can be rearranged and expressed as

$$\frac{1}{2 π} {\int }_{- ∞}^{∞} M ( ω ) G ( ω ) ⅆ ω = {\int }_{- ∞}^{∞} m ( α ) h ( - α ) ⅆ α = \frac{1}{T} {\int }_{- T / 2}^{T / 2} m ( t ) ⅆ t \qquad ( 24 d5 )$$

Note that equation (24d5) involves the use of the Fourier transform. Accordingly,

$$Y ( 0 ) \approx \frac{1}{2} {ⅇ}^{j ϕ} [ \frac{1}{T} {\int }_{- T / 2}^{T / 2} m ( t ) ⅆ t ] = \frac{1}{2} {ⅇ}^{j ϕ} [ \frac{1}{T} {\int }_{- T / 2}^{T / 2} ( {m}_{i} ( t ) - {jm}_{q} ( t ) ) ⅆ t ] \qquad ( 24 d6 )$$

The right hand side of equation (24d6) is identical to the expression for Y(0) in equation 24(d).

$$Now , \frac{1}{T} {\int }_{- T / 2}^{T / 2} A ⅆ t = A \qquad ( 24 e )$$

Further, because h(t) and h*(t) have period T and have no DC component, then the following equations (similar to equations (21) and (22)) are true:

$$\frac{1}{T} {\int }_{- T / 2}^{T / 2} h ( t ) ⅆ t = 0 and \frac{1}{T} {\int }_{- T / 2}^{T / 2} {h}^{*} ( t ) ⅆ t = 0 \qquad ( 24 f )$$

To verify the integrity of these method of equation (24d) of estimating the phase angle, assume that the signal r(t) has a zero mean with a variance characterized by the quantity σᵣ². The zero mean assumption is reasonable here, in part because data is random in nature and all data levels are equiprobable. Because 828 data symbols exist in the segment period T, then the expressions

$$\frac{1}{T} {\int }_{- T / 2}^{T / 2} r ( t ) ⅆ t = 0$$

and

$$\frac{1}{T} {\int }_{- T / 2}^{T / 2} {r}^{*} ( t ) ⅆ t = 0$$

represents zero-mean random variables having approximate variances of
σᵣ²/828 (24g)

Using the assumptions set forth in equations (24e), (24f) and (24g), and rewriting Y(0) from equation (24d) based on those assumptions yields the following expression for Y(0):

$$Y ( 0 ) \approx \frac{1}{2} {ⅇ}^{j ϕ} [ A + {E}_{i} + j {E}_{q} ] \qquad ( 24 h )$$

where Eᵢ and E_{q} represent orthogonal random variables having respective variances of approximately σᵣ²/828. Because this variance is small relative to the quantity A², the phase angle of Y(0) in equation (24h) yields a good estimate of φ. Using the definitions in the ATSC specification, the following numerical values are available:

$$\begin{matrix}A = 1.25 & ( 24 i ) \\ {σ}_{r}^{2} = \frac{1}{4} ( {1}^{2} + {3}^{2} + {5}^{2} + {7}^{2} ) = 21 & ( 24 \text{j} )\end{matrix}$$

Equations (24i) and (24j) establish that A²/σ²=−11.3 dB. This means that, with respect to the digital television signal s(t), the energy in the pilot tone is approximately 11.3 dB below the energy in the data portion of the signal r(t). After processing by the receiver's phase-estimation filter in this implementation, the relative energy of the pilot tone in Y(0) is A²/(2σᵣ²/828), or approximately 14.9 dB. These figures reflect that the filter in this implementation provides a processing gain of approximately 26 dB.

2. Accumulation of Segment Intervals

Following the estimation of phase changes from step 1 and equations (20) and (24) above, the accumulated phase-adjusted complex segment interval signal terms may be computed using the following representation:

$$A ( t ; N ) = {\sum }_{n = 0}^{N - 1} S ( t + nT ) {ⅇ}^{- j {ϕ}_{n}} \qquad ( 25 )$$

This is illustrated at step 1230 of FIG. 12. The above procedure amounts to a coherent combination of phase corrected IF signal segments. As equation (25) reflects, each segment is first adjusted by the associated pilot tone phase shift φₙ estimated in equation set (24) prior to accumulation. Thus, by using the above procedures to estimate phase changes, we now have enough information to accumulate respective segments for correlation purposes. From this information, the appropriate correlation peak may be deduced, and the pseudo-ranges may be calculated, as discussed below. The accumulation step can be readily performed by executable instructions in software using a straightforward summing algorithm, given that previous unknowns (i.e., φₙ) are now known.

By coherently combining phase-corrected IF signal segments, the accumulated term A(t;N) computed in equation (25) in this implementation effectively adds the pilot signal coherently N times. This accumulated expression results in a pilot term having a magnitude stronger than in the original received television signal. As an illustration of this fact, given a frame of N=313 segment intervals, the resulting pilot signal power computed in A(t;313) is 10log₁₀313−12=13 dB above the remaining terms.

Based on this illustration, it follows that the mobile receiver in this embodiment can estimate the pilot tone frequency more accurately after the coherent accumulation of the IF signal segments is computed. The receiver may thereupon estimate this frequency following accumulation.

3. Down-Conversion to Baseband

Given the availability of a reasonably accurate estimate of the pilot tone frequency ωₚ, as discussed below, the complex accumulated signal from equation (25) is next down-converted to a complex baseband signal by multiplying the expression by e^{jω}^{ₚ}^{t} to produce A(t; N)e^{-jω}^{ₚ}^{t} as shown in FIG. 12 (step 1240). This expression is used in connection with the complex correlation procedure, described below. Note that, for the purposes of this disclosure, baseband does not require the down-converted signal to reside precisely at baseband. The approximate nature of this calculation may arise from, among other factors, a close but imperfect estimation of the pilot frequency.

4. Complex Correlation

The final step to obtain the complex accumulated correlation is to compute the following expression (step 1260, FIG. 12):

$$C ( t ; N ) = {\int }_{0}^{T} A ( α ; N ) {ⅇ}^{- j {ω}_{p} t} h ( α - t ) ⅆ α \qquad ( 26 )$$

In the embodiment shown, the computationally intensive correlation operation reflected by equation (26) may be performed once at the end after accumulation, rather than being performed with respect to each of the individual N segment intervals. Performing this correlation operation once at the end can improve accuracy (because, among other reasons, the accumulated signal is more immune to random noise injections) and dramatically reduce computational time at the mobile receiver. In addition, in some embodiments, the mobile receiver may perform the down-conversion and correlation calculations in a single step. As a result, a significant savings in computational power can be achieved, and correlations can be performed faster, thereby allowing the receiver to track position location in up to substantially real time.

Using equations (25) and (26), the mobile receiver in this embodiment correlates both the inphase and quadrature phase components with the real waveform h(t). Ignoring pilot and data modulated signals and focusing only on the segment sync bits waveform, the down-converted complex signal would have the following form:
D(t)=[h(t−τ)+jh*(t−τ)]e^{jφ}for τ≦t+T₀≦T₀ (27)
In equation (27), present are the phase term φ, and the unknown beginning of the segment time τ in the segment interval [0,T]. Autocorrelating both the inphase and quadrature terms with the same waveform h(t) yields the following complex correlator output:
C(t;1)=[Rₕₕ(t−τ)+jR*ₕₕ(t−τ)]e^{jφ} for τ−T₀≦t≦τ+T₀ (28)
The equation (28) represents the same equation computed above in connection with trigonometric property (1) and equations (16) and (17), above.

In certain embodiments, the receiver may use a complex reference waveform during the correlation computation instead of simply using the real component h(t). Here, H(t) may be used as the reference where H(t)=h(t)−jh*(t). In this event, the complex correlator output may be represented by

$$C ( t ; 1 ) = {\int }_{0}^{T} D ( α ) H ( α - t ) ⅆ α for τ - {T}_{0} \leq t \leq τ + {T}_{0} \\ = \{ [ {R}_{hh} ( t - τ ) + {R}_{{h}^{*} {h}^{*}} ( t - τ ) ] + j [ {R}_{{h}^{*} {h}^{*}} ( t - τ ) - {R}_{{hh}^{*}} ( t - τ ) ] \} {ⅇ}^{j ωϕ} \qquad ( 29 )$$

In addition, the following two provable mathematical properties are useful here:
R_{h*h*}(t)=R**ₕₕ(t)=Rₕₕ(t) (30)
and
R_{h*h}(t)=R*ₕₕ(t)=−R_{hh*}(t) (31)

Using the relationships from (30) and (31), equation (29) can be rewritten as follows:
C(t;1)=2[Rₕₕ(t−τ)+jR*ₕₕ(t−τ)]e^{jφ} (32)

Comparing equations (28) and (32) evidences that a receiver using a complex reference waveform as a correlation input produces a similar result, differing in this instance by a factor of 2.

Another alternative to computing the pertinent correlation coefficients is set forth below in the context using matched filtering techniques in connection with a received ATSC digital television signal. In the embodiments discussed, certain simplifying assumptions can be made to produce a correlation result that is reasonably precise. First, the down-converted baseband signal is described. In actual implementations, the down-converted baseband signal has certain second order characteristics and may be more accurately represented by the following expression:
D(t)=S(t)e^{-jω}^{ₚ}^{t}=[(d(t)+A)+jd*(t)]e^{j φ}+e^{-j2ω}^{ₚ}^{t}[(d(t)+A)+jd*(t)]

Here, variable h(t) represents the portion of the modulating signal attributable to the segment synchronization pattern at a time when the segment synchronization signal is centered at t=0. In this event, the pertinent period of the synchronization signal is −T/2≦t≦T/2. The correlation operation to be performed can be expressed by

$$C ( t ) = {\int }_{- T / 2}^{T / 2} d ( α ) h ( α - t ) ⅆ α for - T / 2 \leq t \leq T / 2$$

Here, because h(t) has a period T, the integral above constitutes a circular correlation.

In embodiments using the ATSC format, signals h(t) and h*(t) have low-pass characteristics in light of their general 6 MHz bandwidth-per-channel limitation. If ω₀=2π(6 MHz), then the term e^{-j2ω}^{ₚ}^{t}[(d(t)+A)+jd*(t)] lies outside the passband of h(t) and does not contribute to the correlation C(t). Accordingly, this term drops out from the correlation equation.

After removing the complex term above, the following expressions representing the correlation waveform of the synchronization pattern become simplified to
dᵢ(t)≈A+h(t)
d_{q}≈(t)h*(t)
for some τ and h*(t) represents the Hilbert transform of h(t). In this case, the correlation equation can be rewritten as follows:

$$C ( t ) = {\int }_{- T / 2}^{T / 2} [ A + h ( α - τ ) - j {h}^{*} ( α - T ) ] h ( α - τ ) ⅆ α$$

Note that h(t) has no DC component, since the binary segment synchronization pattern in this embodiment includes toggling symbols (+1, −1, +1, −1). Accordingly, the pilot term “A” does not contribute to the correlation equation C(t). Then, if we define

$$R ( t ) = {\int }_{0}^{T} h ( α ) h ( α - t ) ⅆ α and$$

$${R}^{*} ( t ) = {\int }_{0}^{T} {h}^{*} ( α ) h ( α - t ) ⅆ α ,$$

the following equation for the correlation results:
C(t)≈R(t−τ)−jR*(t−τ) (33)
Next, to solve the correlation function of equation (33), both sides of the equation can be squared to produce
|C(t)|²≈R²(t−τ)+R*²(t−τ) (34)
Because the synchronization signal is centered at t=0 in this illustration, the quantity |C(t)|² in equation (34) is maximized when t=τ. Consequently, to determine the offset τ of the segment synchronization pattern (and ultimately the pseudo-range and position information of the user device), the processor or other component in the user device can first compute the quantity |C(t)|² for −T/2≦t≦T/2. Having computed that quantity, the processor can then determine the value of τ that maximizes the known |C(t)|².

The embodiment described above is insensitive to a fixed signal phase offset. In particular, if the carrier phase estimator includes some fixed phase shift e^{jΦ}, then the correlation equation (33) changes to
C(t)≈e^{jφ}└R(t−τ)−jR*(t−τ)┘ (35)

Equations (34) and (35) reflect that the quantity |C(t)|² is not significantly affected by the value of φ. As such, even if the carrier phase estimator includes a fixed offset, that offset will not affect the matched filter procedures and corresponding determination of τ as described in this section.

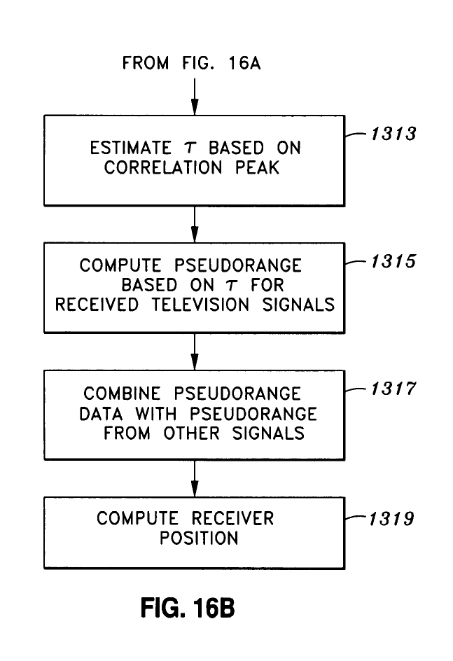

FIGS. 16A and 16B show a flow diagram of an algorithm for computing a correlation peaks and hence the relative time delay τ of an incoming television signal in accordance with one embodiment of the present invention. Before the commencement of the algorithm on a suitable processing device, the analog front end circuitry of the receiver tunes, filters, retimes, amplifies and digitizes the incoming signal in a manner described above (step 1301). Once the broadcast television signal is digitized by the analog-to-digital converter, the signal is ready for input into a processing device for further manipulation. In this example, the digitized signal from an appropriate set of analog to digital converters resides at an intermediate frequency (IF) such that successive signal intervals of period T remain in a broadband signal format. At step 1303, a processing unit computes the relative phase offsets φ, for each segment interval. In the case of an ATSC-based signal, the segment interval would constitute a data packet (or alternatively, a field synchronization segment) of 832 symbols in length, or a duration T of 77.3 μS each. Within each such interval is included a known signal component—namely, the four symbol data synchronization segment at the beginning of the packet. For different types of television signals, it will be appreciated that different symbol lengths may be involved, and the types of known signal components may vary. The computations of the phase offsets φ are performed for successive intervals of signal segments so that each offset associated with each of the received segments are known. When a sufficient number of segments are computed based on criteria such as the computational capacity of the receiver and the desired accuracy of the calculation of the time delay coefficient τ, the measurements of the phase angle may conclude. Concurrently, or shortly thereafter (depending on the software implementation), the phase of each of the N IF waveforms is adjusted based on the calculated phase offset (step 1305) from step 1303. With that adjustment, the successive segment intervals may be accumulated together as shown in step 1307. Depending on the embodiment, the accumulation process may occur after each phase angle is computed for a given segment interval, or it may occur after all of the necessary phase offsets have been recorded. At step 1309, the accumulated signal A(t;N) is downconverted to a baseband (or substantially baseband) signal by multiplying the accumulated signal A(t;N) by an exponent containing an estimated or known pilot frequency.

Next, at step 1311, the resulting baseband accumulated signal is correlated with the reference waveform (the latter constituting a representation of the data synchronization segment in this example) to establish a correlation function with a series of peaks. The first peak which ordinarily corresponds to a line of sight reception of the television signal without multipath interference, is chosen from which to calculate the relative time delay between the transmission of the known signal component at the television transmitter to the reception of the commencement of that component at the receiver.

Continuing to FIG. 16B, using conventional methods, this correlation peak is used to calculate the quantity τ (step 1313). Based on the calculation of τ, an appropriate pseudo-range for the received television signal is calculated using one of a variety of known methods (step 1315). The pseudo-range in step 1315 may be calculated at the receiver; alternatively, the time delay information from the receiver may be transmitted to a remote device such as a location server, which may instead perform the calculation. The specific location where the pseudo-range itself is computed is not essential to an understanding of the present invention. In step 1317, the pseudo-range data computed by the receiving device may then be compared with similar pseudo-range data obtained from other receiving devices using GPS signals or television signals, as is well known in the art. This step may likewise be accomplished by the receiver itself, or more typically, by an external device in communication with the receiver over a wireless network. At step 1319, the position of the receiver is computed based upon these pseudo-ranges. In the case where a separate device (such as, for instance, a location server) performs these computations, the resulting position information can be relayed back to the receiving device through the wireless network or other means.

Computer-executable process steps of the present invention can be executed on any computer including PCs, workstations, servers, mainframes, and supercomputers without departing from the scope of the present invention. The computer can have any type of CPUs, including Intel CPU, a PowerPC CPU, a MIPS RISC CPU, a SPARC CPU, a DSP, an Alpha CPU or a proprietary CPU for a mainframe or supercomputer, without departing from the scope of the present invention. The computer-readable medium can be any data storage medium including magnetic disk and tape media, optical media, and magneto-optical media without departing from the scope of the present invention. The computer-readable medium can also be a ROM or flash ROM for firmware. The computer-executable process steps of the present invention can also be executed by a dedicated and/or specialized digital and/or analog circuits without departing from the scope of the present invention.

Using the A TSC Field Synchronization Segment

The method described here has focused on correlating the accumulated phase-corrected segment intervals with the known waveform of the 4 segment synchronization bits. The resulting correlation peak can be used to compute a pseudo-range for determining the receiving device's position location. These segment synchronization bits occur in every segment interval transmitted by the ATSC digital TV broadcast signal. As shown in FIG. 9, the Field Synchronization Segments 910 are also known signals terms that can be used for computing a pseudo-range and providing additional means for determining the receiving device's position location. We describe next how this can be done using the method described in this application.

Note that correlating the accumulated phase-corrected segment intervals with the known segment synchronization bits results in a correlation peak that identifies for the receiver the previously unknown beginning of the segment interval in the received broadcast signal. This is because these 4 segment synchronization bits are always at the beginning of each ATSC digital TV transmitted signal's segment interval. Once this correct segment interval for the received signal is determined a new corrected segment interval can be used for computing additional accumulated phase-corrected segment intervals. This corrected segment interval is the receiver's estimate of the actual segment intervals in the received broadcast signal.

Using the corrected segment intervals for the received signal, the method described here is extended to creating 313 accumulated phase-corrected segment intervals. This corresponds to the 313 segments in a half frame shown in FIG. 9. Here each received segment interval is phase corrected and added to one of the 313 accumulated segment intervals. These accumulations are done in sequence such that a phase corrected segment interval is added to a particular accumulator once every 313 segment time intervals. Thus each of these 313 accumulators have a new phase-corrected segment added to it once every 313×77.3 microseconds=24.2 milliseconds or 41.3 times a second.

Only one of the 313 accumulated phase-corrected segment intervals corresponds to the fixed Field Synchronization Segment as shown in FIG. 9. Except for the few bits that differ between Field Synchronization Segment #1 and #2, this accumulated segment intervals will coherently combine the phase-corrected segment intervals resulting in much larger sample magnitude values than the other 312 accumulated phase-corrected segment intervals which consists of random data symbols. All of these segments, of course, still have the common pilot signal and segment synchronization bits that add coherently in all the accumulated phase-corrected segment intervals.

After some accumulations, the accumulated segment interval containing the Field Synchronization Segment will have total energy that exceeds the other 312 accumulated segment intervals with high probability. This accumulated segment interval can be easily identified using some threshold on the total energy in each of these 313 accumulated segment intervals. Once this accumulated segment interval containing the Field Synchronization Segment is identified it can be correlated with the known waveform of the Field Synchronization Segment. The resulting correlation output can be used to compute a pseudo-range which can be combined with the earlier pseudo-range measurement based on the segment synchronization bits discussed earlier.

Application to the Analog NTSC Broadcast

Like the digital ATSC standard, the analog National Television System Committee (NTSC) broadcast signals also contain a pilot signal and other known synchronization signal components that can be used for the receiver's position location. The method described in this application applies directly to the analog NTSC broadcast signals. For example the horizontal scan synchronization signal occurs in each horizontal scan time of 63.6 microseconds. This 63.6 microsecond is equivalent to the segment time interval discussed earlier while this horizontal scan synchronization signal plays a similar role to the segment synchronization bit waveform of the digital ATSC standard. For these analog TV broadcast signals there is also a known Ghost Canceling Reference (GCR) signal that occurs periodically which is used by the TV receivers to combat multipath during signal propagation from the transmitter to the receivers. This GCR signal is analogous to the Field Synchronization Segment signal of the digital ATSC broadcast signal. The method of this application easily extends to all other types of analog TV broadcast signals.

Extension to Other Digital TV Standards

The European Telecommunications Standards Institute (ETSI) established the Digital Video Broadcasting—Terrestrial (DVB-T) standard which is based on the use of Orthogonal Frequency Division Multiplexing (OFDM) signals. This method described here can be applied to DVB-T and the closely related Japanese Integrated Services Digital Broadcasting—Terrestrial (ISDB-T) system. The 8K mode of the DVB-T system, for example, consists of 6,816 OFDM carriers where each carrier is QAM modulated (QPSK is a special case) with a coded data symbol of 896 microsecond duration. The entire set of 6,816 data symbols is referred to as one symbol of this DVB-T broadcast signal. The individual QAM modulated symbols with carriers of 896 microsecond duration are sometimes called cells. Many of these cells are fixed and used for the purpose of synchronization at the TV receivers. These known synchronization cells, called pilot carriers or cells, can be used to determine the receiver's position location based on the method of this application.

For the 8K mode of the DVB-T broadcast standard there are 177 continual pilot cells that occur on the same carrier positions among the 6,916 OFDM carriers in every symbol time of 896 microsecond duration. In addition there are scattered pilot cells that have a pattern that repeats every four symbol times. Reference waveforms based on these known pilot cells can be used to correlate with the received broadcast signal to compute pseudo-ranges for the purpose of position location. Here it is natural to take samples of the Fourier Transform of the broadcast signal for time intervals of one symbol time (896 microsecond) or 4 symbol times (3594 microsecond).

Extension to Other OFDM Broadcast Signals

The method can be applied to other OFDM broadcast signals such as the ETSI Digital Audio Broadcast (DAB) and the United States In-Band On-Channel (IBOC) digital audio broadcast systems. OFDM audio broadcast signals are also used by the terrestrial relays of the Satellite Digital Audio Radio Service (SDARS) systems of Sirius and XMRadio. All these OFDM broadcast signals have known synchronization signal components where the method applies for the purpose of position location.

Open Loop Pilot Frequency Acquisition

As noted above, the carrier or pilot frequency of a radio signal can drift due to oscillator instability. In many applications, including the software receiver-based implementations disclosed above, the receiver should be able to rapidly acquire the unknown carrier frequency of the transmitted signals. In one embodiment, this acquisition is performed in software by the processor. An open-loop frequency acquisition scheme will now be described. The scheme can be applied to any broadcast signal in which a pilot carrier signal is embedded. While numerous such signals exist, some of which are described above, one example includes an ATSC digital television signal. The estimated pilot frequency may be used in the above steps for accurate down-conversion, proper filtering, and accurate and efficient tracking of received signals through phase-locking techniques.

Before discussing the details of acquiring the pilot signal in accordance with various aspects of the present method, certain pertinent mathematical relationships will first be considered. The transmitted signal at the receiver can be represented as a pilot signal with additive noise as shown:
y(t)=A cos [2πft+φ]+n(t) (36)
Equation (36) represents a signal having a pilot tone of amplitude A, frequency f, and phase φ together with a noise term n(t) which represents the collection of random noise in the receiver front end, other parts of the transmitted signal, and interference from other sources. We assume that the receiver does not know these three pilot tone parameters {A, f, φ}.

The received pilot signal can also be represented as a complex waveform given by
Y(t)=Ae^{j[2πft+φ]}+N(t) (37)
where j=\sqrt{−1} and N(t) is a complex noise process. The real part of this complex waveform constitutes the received signal.

In some implementations, the receiver has knowledge of the transmitter signal's ideal designed carrier frequency fₒ. As noted above, this ideal frequency often differs from the received carrier frequency, due in part to oscillator drift. Typically the transmitter's oscillator is designed to maintain a frequency that is within some range around the ideal design frequency. In one embodiment, the maximum offset is bounded by a known quantity Δ such that the actual transmitter carrier frequency f is within Δ of the ideal design frequency. Thus the following relationship can be expressed:
|f−fₒ|≦Δ
In many implementations, received signals are translated to baseband inphase and quadrature signal components relative to the receiver's estimate of the carrier frequency. The complex baseband signal at the receiver may then be estimated by multiplying the complex received signal by the reference carrier. Thus, multiplying the received pilot signal from equation (37) by the complex baseband signal at the receiver using the estimate f₀, the following result is obtained:

$$\begin{matrix}{Y}_{0} ( t ) = Y ( t ) {ⅇ}^{- j 2 π {f}_{0} t} \\ = {A}^{j [ 2 π ( f - {f}_{0} ) t + ϕ ]} + {N}_{0} ( t )\end{matrix} \qquad ( 38 )$$

where Nₒ(t) represent the complex noise term translated to baseband. The real and imaginary components of this complex baseband received signal Yₒ(t) constitute the inphase and quadrature baseband signal components relative to the reference carrier frequency fₒ.

It should be noted that it is often the receiver that may have a relatively unstable oscillator, while the transmitter signal oscillator may be more stable. Here the receiver may estimate the more stable transmitter pilot signal frequency and use this to calibrate its own oscillator frequency. In general, some drift usually is present in both the transmitter signal carrier frequency and the receiver's oscillator. Regardless of the situation, it can be assumed for purposes of calculating pilot frequency that the transmitter pilot carrier frequency is given by f and the receiver's estimate of this frequency is given by fₒ. Based on these general conditions, a robust and effective method of open loop pilot frequency acquisition by the receiver in a processor-based environment is now disclosed.

The receiver can define a “coherence time” T_{c} where the phase change due to the maximum offset in frequency is less than some maximum phase error. As an illustration, this coherence time might be chosen to satisfy

$$Δ {T}_{c} \leq 0.1 or {T}_{c} \leq \frac{1}{10 Δ} \qquad ( 39 )$$

The relationship in (39) ensures in this illustration that the maximum phase change is less than 360°/10=36°.

Next, it should be noted that the receiver will typically receive multiple pilot signal segments from the transmitted radio signal as multiple data segments are received. The received complex signal waveform in this case may be divided into segments of time duration T_{c} and shifted into the interval [0, T_{c}], changing equation (37) as follows:
Y(t+nT_{c})=Ae^{j[2πf(t+nT}^{_{c}}^{)+φ]}+N(t+nT_{c}) (40)
for n=0,1,2, . . . , N−1 where N is the number of received pilot signal segments each of time duration T_{c}. Similarly the corresponding complex baseband signal time shifted segments are given by amending equation (38) as follows:

$$\begin{matrix}{Y}_{0} ( t + {nT}_{c} ) = A {ⅇ}^{j [ 2 π ( f - {f}_{0} ) ( t + {nT}_{c} ) + ϕ ]} + {N}_{n} ( t ) \\ = A {ⅇ}^{j 2 π ( f - {f}_{0} ) t} {ⅇ}^{j [ 2 π {fnT}_{c} + ϕ ]} {ⅇ}^{- j 2 π {f}_{0} {nT}_{c}} + {N}_{n} ( t )\end{matrix} \qquad ( 41 )$$

where Nₙ(t) represents the corresponding complex Gaussian noise term of the n^{th} shifted complex baseband segment signal.

Normally, because the unknown pilot carrier frequency causes phase changes relative to the receiver's carrier frequency, the accumulation of many segments may not be possible. However, a unique phase correction operation, similar to the operation above as applied to the acquisition of synchronization codes, may be applied to each segment to allows coherent accumulation of segments. The total accumulation in one embodiment is performed over as many segment intervals as is needed to obtain the final desired pilot signal-to-noise ratio. The procedure according to one implementation is performed as follows. For each segment we compute the average

$$\begin{matrix}\overline{{Y}_{n}} = \frac{1}{{T}_{c}} {\int }_{0}^{{T}_{c}} {Y}_{0} ( t + {nT}_{c} ) ⅆ t \\ = A \frac{1}{{T}_{c}} {\int }_{0}^{{T}_{c}} {ⅇ}^{j [ 2 π ( f - {f}_{0} ) t} ⅆ t {ⅇ}^{j [ 2 π ( f - {f}_{0} ) {nT}_{c} + ϕ ]} + \overline{{N}_{n}} \\ A ( \frac{sin [ π ( f - {f}_{0} ) {T}_{c} ]}{π ( f - {f}_{0} ) {T}_{c}} ) {ⅇ}^{j π ( f - {f}_{0} ) {T}_{c}} {ⅇ}^{j [ 2 π {fnT}_{c} + ϕ ]} {ⅇ}^{- j 2 π {f}_{0} {nT}_{c}} + \\ \overline{{N}_{n}}\end{matrix} \qquad ( 42 )$$

where \overline{N}ₙ is the time average of Nₙ(t). Note that the term

$$\frac{sin [ π ( f - {f}_{0} ) {T}_{c} ]}{π ( f - {f}_{0} ) {T}_{c}}$$

is close to 1 when |f−fₒ|T_{c} is small which is satisfied by our condition on the coherent time interval T_{c}.
Defining \overline{Y*ₙ} as the complex conjugate of \overline{Yₙ} and |\overline{Yₙ}| as its magnitude, we next define

$${Z}_{n} = \frac{\overline{{Y}_{n}^{*}}}{\vert \overline{{Y}_{n}} \vert} {ⅇ}^{- j 2 π {f}_{0} {nT}_{c}} \qquad ( 43 )$$

for n=0,1,2, . . . , N−1. Here, Zₙ is the n^{th} segment phase correction term that is applied to the n^{th} received signal segment. Note that the term
e^{-j2πf}^{ₒ}^{nT}^{_{c}}
is known to the receiver since it consists of parameters known to the receiver.

To gain insight into this scheme, we now assume that the noise term is zero. That is, \overline{N}ₙ=0. For this noiseless condition we have
Zₙ=e^{jπ(f-f}^{ₒ}^{)T}^{_{c}}e^{-j[2πfnT}^{_{c}}^{+φ]} (44)
When the shifted segment interval received waveform Y(t+nT_{c}) is multiplied by Zₙ, the following expression results:
Y(t+nT_{c})Zₙ=Ae^{j2πft}e^{-jπ(f-f}^{ₒ}^{)T}^{_{c}} (45)
Equation (45) is independent of the index n=0,1,2, . . . , N−1. Thus we can coherently accumulate all of these phase corrected received signal segment intervals to obtain the N accumulated segment intervals given by

$$\begin{matrix}A ( t ; N ) = \frac{1}{N} {\sum }_{n = 0}^{N - 1} Y ( t + {nT}_{c} ) {Z}_{n} \\ = A {ⅇ}^{j [ 2 π f t + φ ]}\end{matrix} \qquad ( 46 )$$

where φ=(f−fₒ)T_{c}/2 is an arbitrary constant phase term in this accumulation of received signal segment time intervals.

In this final accumulation term A(t;N) time averaged noise would appear in the phase adjustment terms {Zₙ} and in the received signal segment waveforms {Y(t+nTₙ)}.

Note that the accumulation of segments given by A(t; N) represents an averaging of N segment intervals corresponding to a total received signal time interval of T_{N}=NT_{c}.

The key result of the above coherent accumulation of segment intervals is a pilot carrier signal at a high signal-to-noise ratio. If we now assume that the noise term is not zero, then we see that for each segment interval \overline{N}ₙ, a noise term time average is present in the n^{th} segment time interval of T_{c}. This time averaging reduces the noise level from that of the original received signal and its effect is to create some noise on the phase of the phase correction term Zₙ. Further reduction of the effects of noise are obtained by the averaging in the accumulation of the phase corrected segment intervals. In particular, as the number of segment intervals N is increased, the signal-to-noise ratio in A(t; N) likewise increases, allowing for correspondingly more accurate estimation of the pilot tone frequency.

Given the accumulation segment waveform A(t; N) there are several ways to estimate the pilot carrier frequency. In one embodiment, the Fourier Transform of A(t;N) is computed. The result is given by

$$B ( γ ; N ) = \frac{1}{{T}_{c}} {\int }_{0}^{{T}_{c}} A ( t ; N ) {ⅇ}^{- j 2 πγ t} ⅆ t \qquad ( 47 )$$

From equation (47), the pilot carrier frequency may be estimated by picking the frequency point γ that gives the maximum magnitude of this Fourier Transform,

$$\hat{f} = {{max}^{- 1}}_{γ} \vert B ( γ ; N ) \vert$$

Assuming for simplicity that there is no noise, we have

$$\begin{matrix}B ( γ ; N ) = A ( \frac{sin [ π ( f - γ ) {T}_{c}}{π ( f - γ ) {T}_{c}} ) {ⅇ}^{j [ π ( f - γ ) {T}_{c} + φ ]} \\ and & ( 48 ) \\ \hat{f} = {{max}^{- 1}}_{γ} \{ A \frac{sin [ π ( f - γ ) {T}_{c} ]}{π ( f - γ ) {T}_{c}} \} = f & ( 49 )\end{matrix}$$

The steps in obtaining an estimate of the transmitted pilot signal's carrier frequency according to one embodiment are now summarized. As noted, this estimate is based on the final accumulation of received signal segments represented by the waveform A(t; N) which is defined over the initial coherence time interval T_{c}.

Step 1—Compute Pilot Baseband Relative to Reference Frequency

For the first step, the pilot signal Y(t)=Ae^{j[2πft+φ]}N(t) is received by the processor and its baseband signal is computed relative to the receiver reference carrier frequency estimate Yₒ(t)=Y(t)e^{-j2πf}^{ₒ}^{t}.

Step 2—Define Time Shifted Segments for Both Signals

A coherent time interval T_{c} may be selected and time shifted segments of duration T_{c} seconds may be defined for both the received signal Y(t+nT_{c}) and its baseband signal Yₒ(t+nT_{c}) for n=0,1,2, . . . , N−1.

Step 3—Compute Phase Correction Terms

Next, phase correction terms for each value of n may be computed using the following expression:

$${Z}_{n} = \frac{\overline{{Y}_{n}^{*}}}{\vert \overline{{Y}_{n}} \vert} {ⅇ}^{- j 2 π {f}_{o} {nT}_{c}} \\ where \overline{{Y}_{n}} = \frac{1}{{T}_{c}} {\int }_{0}^{{T}_{c}} {Y}_{o} ( t + nT ) ⅆ t for n = 0 , 1 , 2 , … , N - 1. \qquad ( 50 )$$

Step 4: Phase Correct Each Received Signal Segment

Each received signal segment may then be phase corrected, using the results obtained from equation (50) above, by multiplying the received signal by the phase corrected term Y(t+nT_{c})Zₙ and then accumulating phase corrected received signal segments over the interval from 0 to N−1 as shown:

$$A ( t ; N ) = \frac{1}{N} {\sum }_{n = 0}^{N - 1} Y ( t + {nT}_{c} ) {Z}_{n} \qquad ( 51 )$$

Step 5: Estimate the Carrier Frequency

Estimate the carrier frequency using any suitable method on this accumulated segment of sufficiently large N. The Fourier Transform method computes

$$B ( γ ; N ) = \frac{1}{{T}_{c}} {\int }_{0}^{{T}_{c}} A ( t ; N ) {ⅇ}^{- j 2 πγ t} ⅆ t$$

and estimates the pilot carrier frequency by picking the frequency variable γ that is the maximum magnitude point of this Fourier Transform,

$${f}^{Λ} = {{max}^{- 1}}_{γ} \vert B ( γ ; N ) \vert .$$

The mathematical techniques described above can be “transcribed” into executable code for use on a processing device. Thus, the estimation of the pilot frequency can be performed in software. The receiver front end can, as a result, be greatly simplified. Advantages may include, among others, smaller power usage, faster estimation of the pilot frequency than would be possible in a complex hardware implementation, and computation of the pilot frequency in far fewer instructions per second (MIPS) than would otherwise be required. As in the acquisition of the synchronization codes, the estimation of the pilot frequency may be performed by a digital signal processor, general purpose processor, RISC-based processor, processor core, various logic devices, etc.

Estimating Television Broadcast Pilot Signal Frequency

A number of applications are possible using the pilot frequency estimation steps described in this disclosure. One such application relates to estimating the television broadcast pilot signal frequency. This information can thereupon be used to lock onto the television signal and to accurately down-convert the signal, as appropriate, to a baseband format for further processing.

As noted above, most analog and digital television signals have a pilot signal embedded in their transmitted broadcast signal. The method described here can be used by a receiver to estimate the carrier frequency of these broadcast television signals. Consistent with earlier descriptions, an example using the United States ATSC digital television standard broadcast signal will now be described.

The ATSC broadcast signal, as noted, contains three bit amplitude symbols that modulate a carrier using an 8-VSB modulation scheme together with a pilot signal that is approximately 12 dB smaller than the data part of this signal. For a receiver that is attempting to estimate the pilot signal carrier frequency, the additive noise term is primarily due to this data portion of the broadcast signal. Hence the complex received signal given by the expression Y(t)=Ae^{j[2πft+φ]}+N(t) has the pilot signal with unknown carrier frequency f embedded in a stronger 8-VSB modulated broadcast signal term of 6 MHz bandwidth given by the complex additive “noise” term N(t).

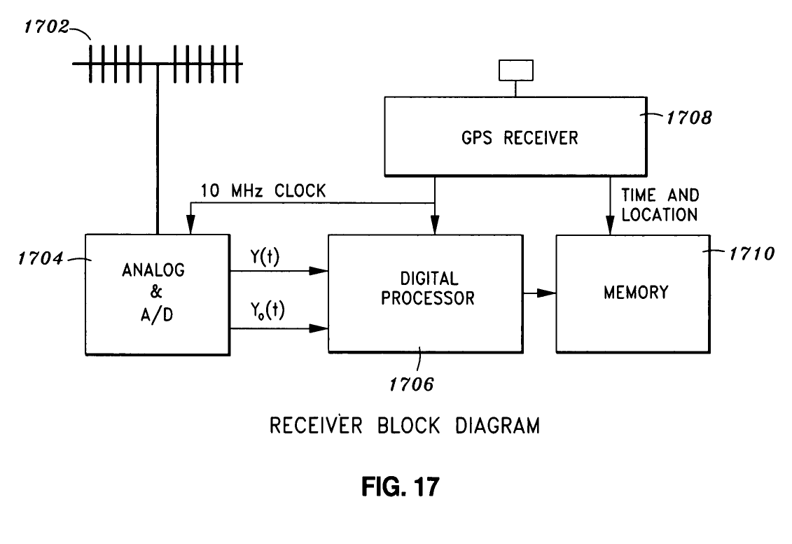

For this application, it can be assumed the receiver has a very stable oscillator. Achieving this stability may be possible using a 10 MHz clock derived from a GPS receiver. FIG. 17 depicts a simplified block diagram of a receiver in accordance with an embodiment of the present invention. The receiver includes antenna 1702 for receiving broadcast television and GPS signals, an analog front end and a corresponding analog to digital converter 1704, a memory circuit 1710 for storing executable instructions and other information relevant to the signal processing steps, and a digital processor 1706 (such as a CPU or DSP, etc.) for performing the routines for tracking the received signal and estimating the pilot frequency as described in this disclosure. Here the analog front end 1704 provides to the digital processor 1706 the complex received signal Y(t) and its baseband version Y₀(t) centered on the ideal expected pilot carrier frequency fₒ that is derived in some configurations from a stable GPS reference clock. The reference clock signal in this illustration is coupled to the analog front end 1704. Time and location information may be transmitted from the GPS receiver 1708 for storage in memory 1710. The digitized signals are processed in digital processor 1706 using the steps described above for estimating pilot frequency.

This digital television broadcast signal sends packets referred to herein as segments. Accordingly, the segment time interval in this embodiment is the natural choice for the coherent time for estimating the pilot carrier frequency. Thus let the receiver select
T_{c}=77.3 μs.
This time T_{c} (referenced in connection with some embodiments as T₀) represents the period of the segment. Note that this segment time interval is based on the receiver's clock and will not be precisely the same as the unknown true packet or segment time interval of the broadcast television signal. This segment time can be flexible as long as it is well within the coherence time of the digital television pilot carrier frequency oscillator.

During the segment time interval, the pilot carrier represents a constant value in the complex baseband signal. There are, however, approximately 832 random data symbols in the additive noise term. Time averaging the baseband signal over the segment time interval (step 3, above) results in a pilot signal-to-noise ratio of approximately
10log₁₀832−12=17.2 dB
Thus the phase correction terms {Zₙ} provide an accurate estimate of the phase shift of the pilot signal in each segment.

If the phase corrections terms are ideal, then the pilot signal in the accumulated segment interval A(t;N) has a processing gain given by
10log₁₀N

Because the number of segment terms in this accumulator can be arbitrarily large and independent of the coherence time, the receiver can obtain an accurate estimate of the pilot carrier frequency by selecting a large enough value of N to produce the desired signal-to-noise ratio. For example, the ATSC transmitted segments have frames consisting of 313 segments. For N=313 the pilot signal-to-noise ratio in A(t;313) is approximately
10log₁₀313−12=13 dB

The receiver described in some configurations may include a monitor receiver that measures the signal parameters of broadcast television signals. In addition to the pilot carrier frequency, such monitor receivers can also estimate the symbol rate in these broadcast television signals and record these parameters with the GPS provided time stamps.

Here we selected parameters T_{c} and N to be natural for the ATSC signal structure. However these choices are arbitrary as long as T_{c} satisfies equation (39).

Calibrating the Receiver Oscillator Using a Television Broadcast Pilot Signal

In another embodiment, a receiver may not have a stable oscillator and instead may use the more stable television broadcast pilot signal to calibrate its own oscillator. This receiver may, for example, be a small mobile device that uses television broadcast signals for the purpose of locating its position. The block diagram of such a receiver in some implementations is substantially identical to that shown in FIG. 17, but without the GPS receiver 1708 and associated connections. It is assumed in this implementation that the television broadcast pilot signal carrier f is stable while the receiver's reference carrier frequency fₒ is much less stable. The same monitor receiver operations as in the example above provide to the receiver in this application an estimate of the television pilot signal carrier frequency. Once the receiver measures the television broadcast pilot signal carrier frequency it can then calibrate its own oscillator accordingly.

The steps followed by the receiver in this calibration procedure may be substantially identical to those described for the receiver in FIG. 17. The most notable difference is that the estimated pilot carrier frequency is used by the receiver to calibrate its own oscillator.

Detecting and Locating Radio Tags

The principles of the present invention may also be used for detecting and locating radio tags. Small radio tags are devices that can be attached to mobile objects for the purpose of tracking and locating these objects. In this application we consider simple radio tags that transmit a signal pulse of duration T₂, where the transmission times of these pulses are arbitrary. The radio tag pulse transmission times may be programmed and controlled by a clock and processor embedded into these radio tags. These tags can be used to track packages, cars, people, animals, etc.

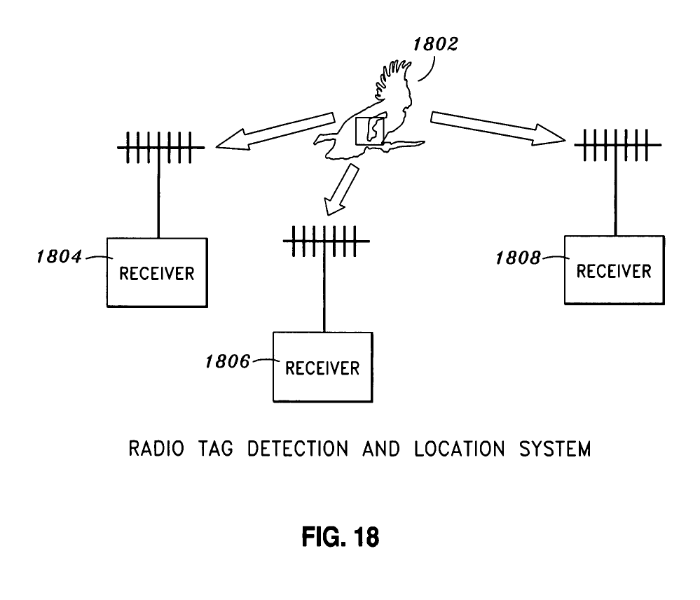

FIG. 18 shows conceptual diagram of a system for locating the position of radio tags used for tracking animals. A tagged bird 1802 is shown as an example. The radio tag sends a fixed binary chip sequence of N₂ binary chips that is modulated onto a carrier of frequency f using Binary Phase Shift Keying (BPSK). The binary modulation rate is R₂ chips per second and the duration of this binary chip sequence is T₂ seconds. We assume that the same binary chip sequence is transmitted at times that are programmed into the radio tag. Here we have the relationship
N₂=R₂T₂.
If three or more receivers 1804, 1806 and 1808 detect and accurately record the arrival times of a tag signal, then it is possible to determine the location of the tagged bird 1802 illustrated in this figure. The accuracy of this location position of the tagged bird will depend on many design parameters of both the radio tag signal and the receiver system.

We first examine the key design issues of the receivers for this system. Implementation of the basic receiver will drive the selections of the tag signal parameters {f, T₂, R₂}. To detect and locate the position of tagged animals in a practical environment, many receivers may be needed. Each receiver may consist of an antenna, an RF front end, and digital components which include digital processing and storage. The antenna system may be important to the overall performance of this system but will not be addressed here since it can be independently designed for each system of receivers by those skilled in the art.

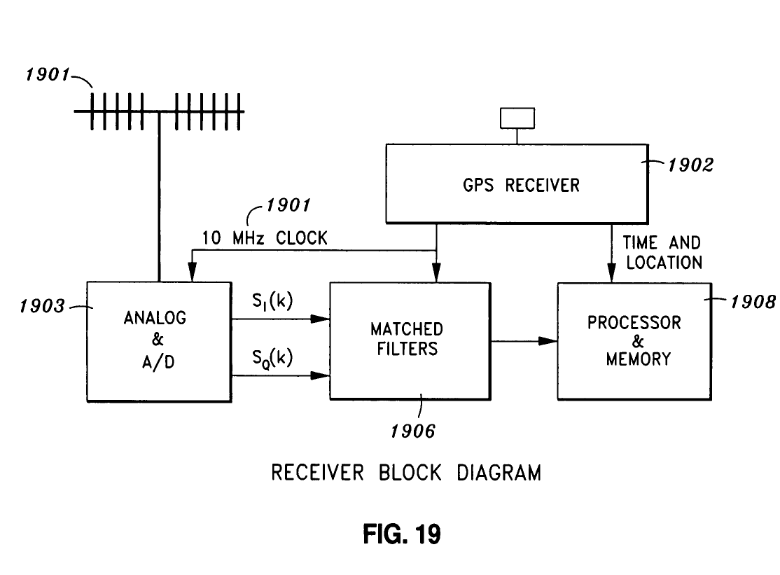

FIG. 19 shows a block diagram of a receiver used for detecting and locating the position of radio tags. The receiver includes an antenna 1901 and analog front end 1903 for receiving tag signals. A GPS receiver 1902 may provide precise location of the receiver and an accurate clock to time stamp detected tag signals. An accurate 10 MHz synchronization signal may be provided by the GPS receiver 1902. Processor and memory circuitry 1908 may be coupled to the GPS receiver 1902 and digital matched filters 1906. The synchronization signal may be used to create a common reference for the circuits of the receiver. Inphase and quadrature digital matched filters 1906 may be used to correlate the tag signal chip sequence with the received inphase and quadrature baseband sampled sequence. The sum of the squares of these matched filter outputs may be compared continuously to a threshold value. Whenever the matched filter output exceeds the threshold, the time may be recorded and stored in memory for later off-line processing to determine locations of the tagged animal. In this illustration, the GPS clock may provide time to within ten nanoseconds, which translates to a distance error of approximately three meters. A more detailed discussion of the received signal and matched filters is set forth below.

The ideal tag signal at the receiver without noise or distortion has the form
s(t)=c(t)cos [2πft+φ]
where c(t) is the chip sequence modulating the inphase arm of the carrier of frequency f. Here φ is an unknown phase term. The carrier frequency is ideally given by the designed value of fₒ. Here the actual tag carrier frequency is given by f which is offset due to the limited oscillator stability in the tag transmitter circuits.

The analog front end 1903 may convert the received signal to baseband inphase and quadrature components relative to the ideal carrier fₒ resulting in the inphase component
s_{I}(t)=c(t)cos [2π(f−fₒ)t+φ]
and quadrature component
s_{Q}(t)=c(t)sin [2π(f−fₒ)t+φ]
which are then sampled at times tₖ=kTₛ where Tₛ is the sampling time interval and Rₛ=1/Tₛ is the sampling rate of the A/D circuits (1903). The sampled inphase and quadrature sequences
s_{I}(k)=c(k)cos [2π(f−fₒ)kTₛ+φ] (52)
and
s_{Q}(k)=c(k)sin [2π(f−fₒ)kTₛ+φ] (53)
accordingly represent the inputs to digital matched filters which detect the presence of the tag signal at the receiver.
Suppose the sampling rate, Rₛ, is set at L times the chip rate such that
Rₛ=LR₂
Typically L=3 samples per chip may be used in practice. Here the total number of samples during the T₂ seconds of the tag signal chip sequence is
K=LN₂

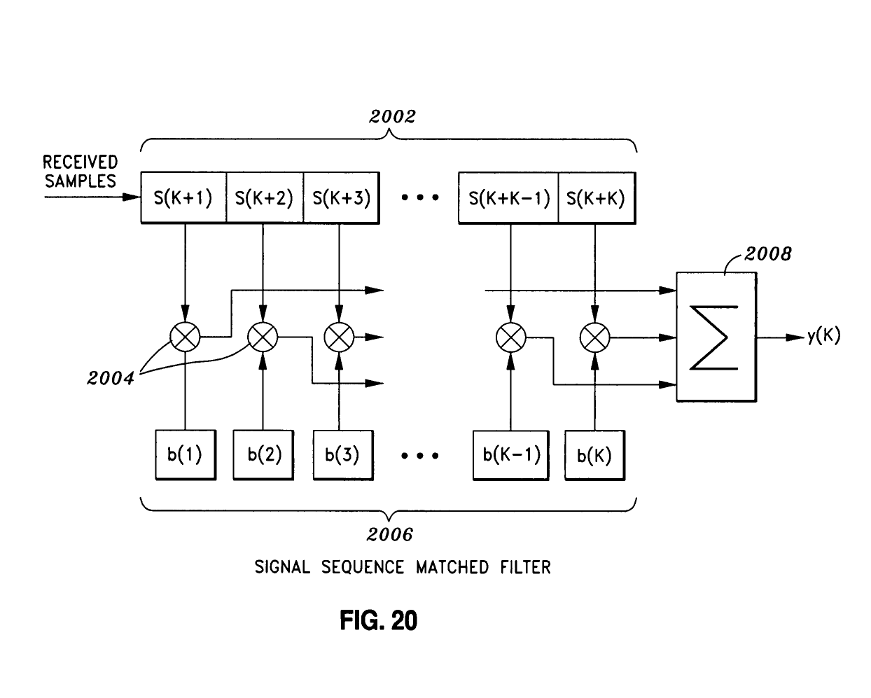

FIG. 20 is a block diagram of a matched filter in accordance with an embodiment of the present invention. The matched filter in this implementation may be applied to both the baseband inphase and quadrature signal components described in equations (52) and (53) above. The matched filter includes a plurality of stages of received samples 2002, represented by s(k+1) through s(k+K). A plurality of reference sample chip sequences 2006 corresponds to each of the plurality of received samples 2002. Coupled to each respective received sample and reference sample is a multiplier, creating a corresponding plurality of multipliers 2004. Each of the multipliers is fed into the input of an accumulator circuit 2008.

A key parameter is the number of samples K corresponding to the total tag signal chip sequences having time duration T₂ and given by the following relationships:

$${T}_{2} = {KT}_{s} = \frac{K}{{R}_{s}} = \frac{{N}_{2}}{{R}_{2}} = \frac{K}{{LR}_{2}} \qquad ( 54 )$$

For every sample time there are K multiplies and one accumulation of all outputs of the multipliers. Suppose that the sample rate is Rₛ=1 MHz and the tag signal total sequence time duration is T₂=10 ms. Then we have K=10,000 multiplies every sample time interval of Tₛ=1 μs. This matched filter then must compute about 10¹⁰ multiplies a second.

The binary chip sequence at the sample times is represented by the sample sequence {b(k)}. This reference sample sequence is used as a matched filter for both the received inphase and quadrature sample sequence resulting in the correlation outputs given by

$${y}_{I} ( k ) = {\sum }_{n = 1}^{K} {s}_{I} ( n + k ) b ( n )$$

$$and$$

$${y}_{Q} ( k ) = {\sum }_{n = 1}^{K} {s}_{Q} ( n + k ) b ( n )$$

The summation in these matched filters corresponds to the number of samples in T₂ seconds, the time duration of the tag signal's chip sequence transmission.

The final output of the matched filters is the sum of the squares of the inphase and quadrature matched filter outputs given by the samples
z(k)=y_{I}²(k)+y_{Q}²(k).
A detection threshold A may be selected so that each receiver records the times during which
z(k)≧Λ
These threshold crossings may be time-stamped and stored in memory at the receiver.

As noted above, the selection of the ideal carrier frequency of the tag signal may be based on some constraints of the receiver. Within the allowed set of possible carrier frequencies, however, the selection of carrier frequency should be based in propagation and antenna efficiency considerations. If the tag's transmitted signal power at the receiver is P, then the energy per transmitted code sequence is E=PT₂. The maximum range over which the receiver will be able to detect the tag's signal is directly dependent on this energy E of the tag signal chip sequence. To maximize this distance for a given power level the goal is to make the sequence time T₂ as large as possible.

Aside from the complexity of the matched filters, the maximum time interval T₂ is limited by the stability of the carrier frequency of the tag's signal. Suppose that, in one implementation, the actual tag carrier frequency is f while the ideal design frequency is fₒ. Then the total tag signal time interval T₂ is limited to the coherence time give by T_{c}. This constraint is imposed by the receiver matched filters performance which depends on limiting the phase changes during the entire sampling time of the signal to be detected.

As an example, suppose that the tag oscillator is stable to 20 ppm (parts per million) at the carrier frequency fₒ=100 MHz. Then the coherence time interval constraint is
T₂≦50 μs
if we require the phase change in T₂ to be less than 36°.

The tag chip rate R₂ has a direct relationship to the location accuracy that is achievable. The matched filter outputs have a correlation peak width that is proportional to the inverse of the chip rate. The GPS chip rate is one million chips per second. Under ideal conditions this chip rate can allow the system to locate the tagged animal's position to within 50 meters.

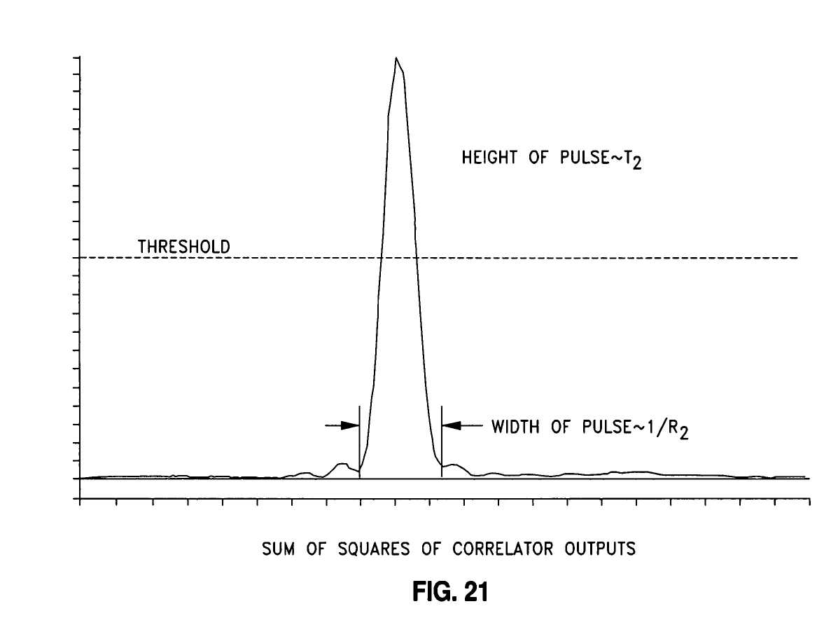

FIG. 21 represents a graph of the correlator output of the matched filter in accordance with an embodiment of the present invention. The ability to accurately detect the tag signal depends on the total energy of the received tag signal. That energy is proportional to the total signal time interval T₂. The accuracy of location depends on the width of the correlation peak, which as shown in FIG. 21 is inversely proportional to the chip rate R₂.

The ability of a set of receivers to detect and locate a radio tag signal increases with the signal correlation time T₂, which is possible if the receiver has a more accurate estimate of the tag's signal carrier frequency f.

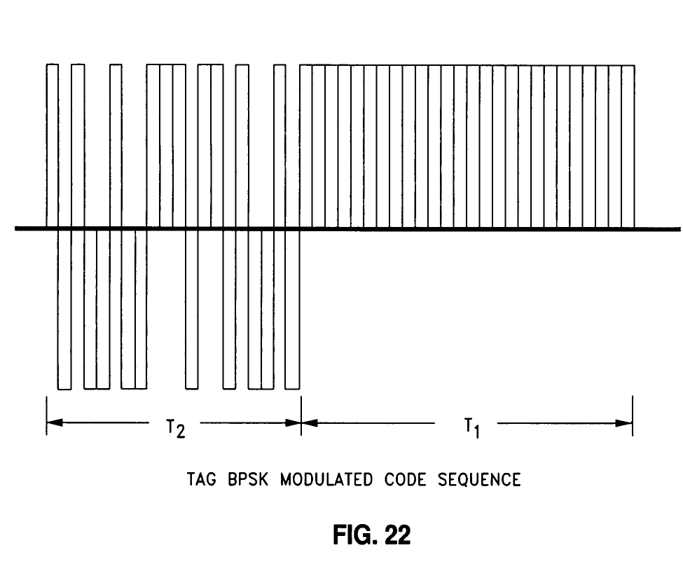

In some implementations, the tag signal is modified to transmit its pulse in two parts: first a pilot signal of duration T₁ followed by the chip sequence of duration T₂. Assuming that BPSK modulation is used, this two-part pulse represents a binary code sequence that transmits a constant {+1} sequence for T₁ seconds and a pseudo-random code sequence of T₂ seconds duration as shown in FIG. 22.

The receiver can first estimate the tag pilot signal carrier frequency during the T₁ second interval using the design described in the above pilot carrier frequency estimation steps. Upon estimating the tag pilot signal carrier frequency, the matched filter detector as describe above can be used to determine the correlator output. Here the correlation time of the matched filter T₂ can be increased due to the pilot signal carrier frequency estimate conducted during the initial T₁ seconds of the tag pulse signal. The pilot signal duration may be set to allow the receiver to detect the random arrival time of the pilot signal as well as estimate its carrier frequency.

This tag pilot signal and the pseudo random coded sequence shown in the above figure can be transmitted separately. Thus there can be a gap time between the two pilot pulse signal of duration T₁ and the pseudo random coded pulse signal of duration T₂.

Because the tag signal is not being transmitted continuously, similar to the matched filters for detecting the chip sequence signal, the natural way to detect and estimate the pilot carrier frequency is to use a sliding block of N segments. This sliding block accumulation of segments has the form

$${A}_{m} ( t ; N ) = \frac{1}{N} {\sum }_{n = 0}^{N - 1} Y ( t + ( n + m ) {T}_{c} ) {Z}_{n + m}$$

where m increases by 1 every segment time T_{c}. The corresponding Fourier Transform terms are given by

$${B}_{m} ( γ ; N ) = \frac{1}{{T}_{c}} {\int }_{0}^{T} {A}_{m} ( t ; N ) {ⅇ}^{- j 2 πγ t} ⅆ t .$$

First the receiver must detect the arrival of the pilot signal. Like the matched filter outputs for detecting the code sequence part of the tag signal, the magnitude of the above Fourier Transform outputs are compared to a threshold every T_{c} seconds when a Fourier Transform is computed.

When a threshold is exceeded for the first time then the pilot signal is assumed to be detected and the pilot carrier frequency is estimated using the threshold crossing Fourier Transform. Thus if the first threshold crossing is detected in the magnitude of the Fourier Transform indexed by m* then the receiver estimates the pilot carrier frequency by picking the frequency variable γ that is the maximum magnitude point of this Fourier Transform,

$${f}^{Λ} = {{max}^{- 1}}_{γ} \vert {B}_{{m}^{*}} ( γ ; N ) \vert .$$

Using the pilot signal carrier frequency estimation system described here, a new radio tag system can be designed to increase the detection range between the tags and receivers. For a given desired detection range the pilot signal time T₁ needs to be set to allow the receiver to detect the random arrival time of the tag pilot signal and to estimate its carrier frequency f. The time it take the receiver to adjust its estimate of this carrier frequency fₒ is the gap time needed before the tag's chip sequence is transmitted. Assuming |f−fₒ| is now much smaller due to this estimation by the receiver, the chip sequence transmission time T₂ is no longer limited by the original coherence time T_{c}.
Receiver Phase-Locking

In another aspect of the present invention, the software receiver may include a phase-locked loop (PLL) for tracking the pilot tone of a television broadcast signal. The example herein is presented in the context of an ATSC-based digital signal.

In one embodiment, the PLL is clocked at the signal's segment frequency, which is approximately 13 KHz. The clocking of the PLL may contain significant amounts of jitter, because the sampling frequency of the receiver may not be rationally related to the signal's segment frequency. Accordingly, a receiver having a PLL is disclosed to address jittery, segment-rate clocking. In some implementations, the PLL can be implemented in code on a processor such as a digital signal processor or general purpose CPU. The PLL may, in some implementations, be used to track the pilot signal after the pilot frequency has been estimated in accordance with the procedures described in this disclosure.

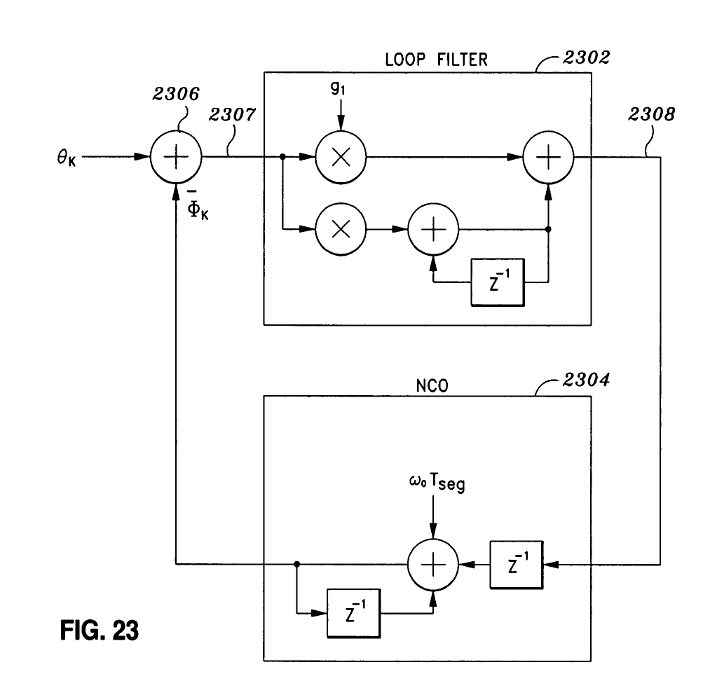

FIG. 23 is a block diagram of phase-locked loop (PLL) used in the receiver in accordance with an embodiment of the present invention. The PLL includes loop filter 2302, numerically-controlled oscillator 2304, and phase detector 2306. The input to the PLL is θₖ, where θₖ represents the phase of the pilot tone at the center of segment k as estimated by a block-phase estimator. The output of the PLL is φₖ, where φₖ constitutes the phase of the pilot tone at the center of segment k as estimated by the PLL. An objective of the PLL in FIG. 23 is that φₖ be a less noisy and more stable estimate of the true pilot-tone phase than is θₖ.

Ideally, the PLL is clocked at the segment frequency of 10.762238 MHz/832=12,935 KHz. In practice, however, the PLL cannot be clocked at exactly the segment frequency because the number of samples in one segment does not represent an integer value. Nevertheless, the foundation for the PLL design in this implementation assumes ideal clocking—namely, clocking at the exact segment frequency.

The numerically-controlled oscillator (NCO) of the PLL in this configuration has a center value of ω₀T_{seg}, where ω₀ is the nominal frequency of the pilot tone and T_{seg} represents the period of the segment frequency. That is, when the NCO is centered, φₖ₊₁−φₖ=ω₀T_{seg}. Stated differently, the center frequency of the NCO is the pilot-tone frequency as aliased by the segment frequency.

In one embodiment, the loop filter 2304 of the PLL is a proportional-integral network. The input 2307 to the loop filter 2304 is the instantaneous phase error θₖ−φₖ. The output 2308 of the loop filter 2304 represents a phase value that adjusts the phase increment of the NCO away from its center value towards the true phase of the pilot tone.

The closed-loop response of the PLL in FIG. 23 is second order. The coefficients of the loop filter are selected in one implementation to provide a closed-loop frequency response having a natural frequency of 100 Hz and a damping factor of 0.707. Different coefficients and frequencies may be used, depending on the implementation and the specific characteristics of the pilot tone at issue.

In a software implementation of the PLL, all phase values may be reduced to a principal value in the interval [−π,π]. In some implementations, a phase value may be represented as a 32-bit signed integer x having a range of [−2³¹, 2³¹], which corresponds to a phase value of (π)(x)(2⁻³¹).

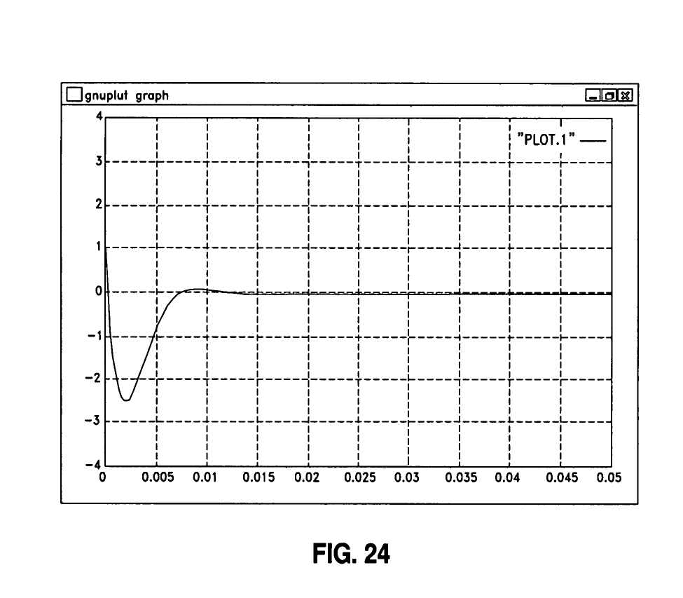

FIG. 24 shows a typical transient response of the PLL of FIG. 23 based on the assumption of ideal clocking. In this example, the input phase sequence θₖ is extracted from a pilot tone that is offset 500 Hz from the center frequency of the NCO. The horizontal axis is time, in seconds. The vertical axis is the phase error θₖ−φₖ, in radians. The transient illustrated is consistent with a second-order system having a natural frequency of 100 Hz and a damping factor of 0.707, as used in the example above.

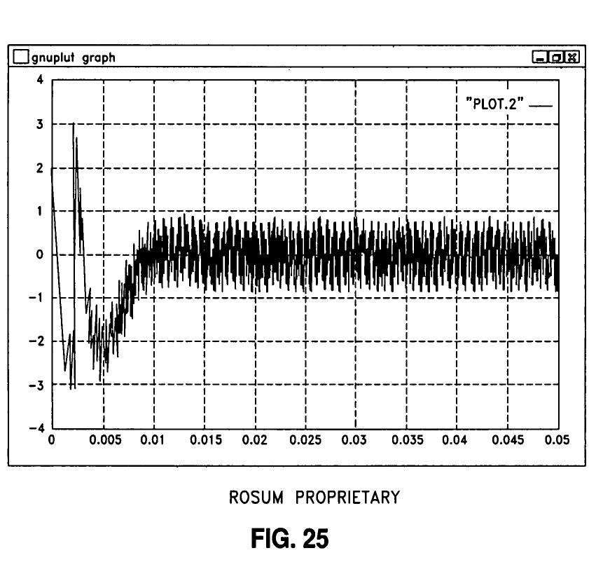

Referring in more detail to the clocking of the PLL, assume that the sample rate is 27 MHz. Thus, the number of samples T in one segment is represented by 832×27/10.762268=2087.298 samples. As noted above, this is not an integer value. In one implementation, segment k can be defined to have a length of Nₖ samples, where Nₖ is either 2087 or 2088. The sequence {Nₖ} is constructed such that the cumulative value N₁+N₂+Nₘ is as close to mT as possible for each value of m. The PLL can be corrected accordingly to compensate for the non-integer nature of the per-segment samples. If no correction is made to the PLL design, this “sample-time clocking” introduces potentially significant amounts of jitter. FIG. 25 is a plot which shows an example of the jitter. This example is identical to that of FIG. 24, except that sample-time clocking is used instead of ideal clocking. The plot shows a heavy jitter associated with the steady-state phase error θₖ−φₖ.

In one embodiment, the PLL design for sample-time clocking may be corrected as follows. First, NCO scaling can be used. When processing segment k, the center of the NCO is scaled by the quantity Nₖ/T. That is, the center value of the NCO is

$$( {ω}_{0} {T}_{seg} ) ( \frac{{N}_{k}}{T} ) .$$

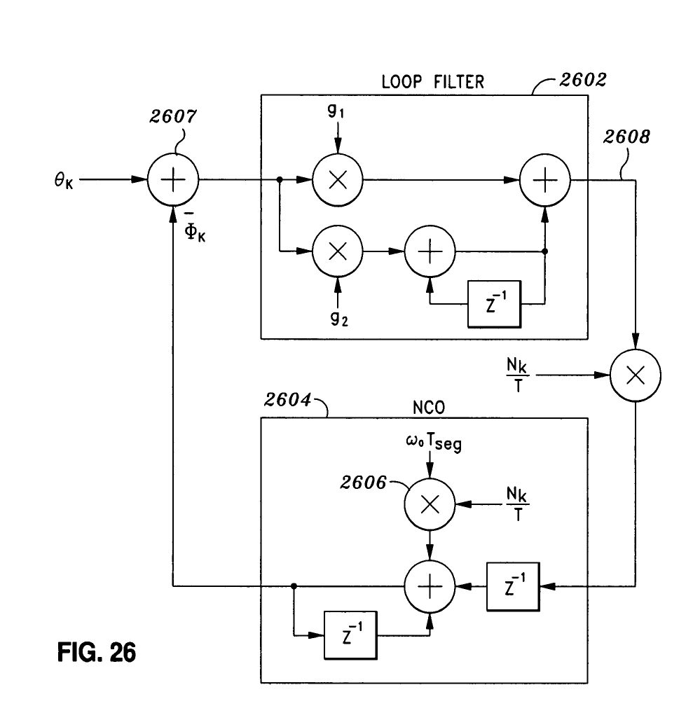

(In addition, loop-filter scaling can be performed. When processing segment k, the output of the loop filter is scaled by Nₖ/T. That is, if xₖ represents the output of the loop filter, then the value applied to the NCO input is xₖNₖ/T. FIG. 26 shows a modified PLL employing these scaling techniques. The loop filter 2602 and phase detector 2607 of FIG. 26 are the same as those in FIG. 23. Multiplier 2605 is added which scales the output 2608 of the loop filter 2603 by Nₖ/T. Similarly, multiplier 2606 is inserted into the NCO 2604 and is used to scale the NCO 2604 value by the quantity

$$( {ω}_{0} {T}_{seg} ) ( \frac{{N}_{k}}{T} ) .$$

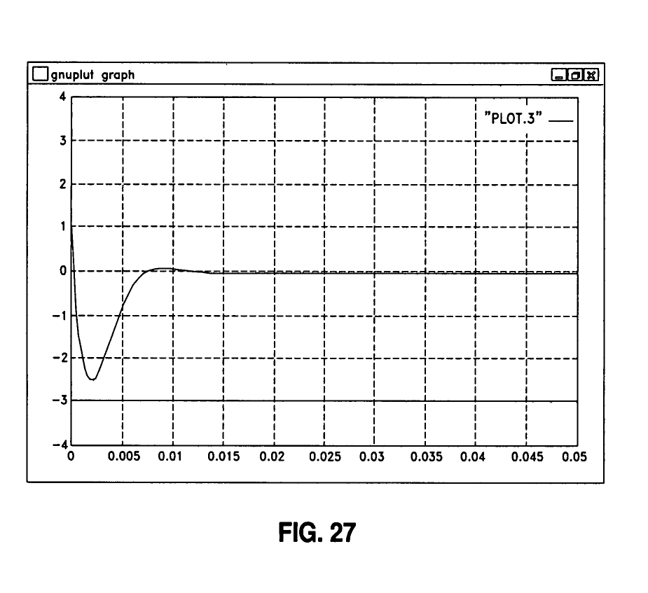

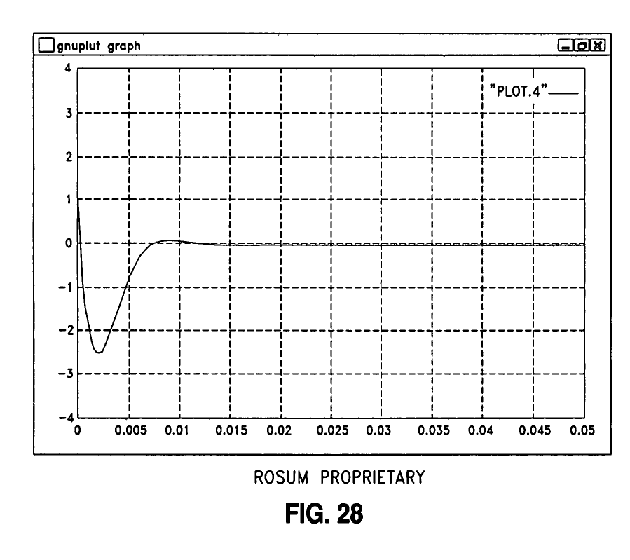

FIG. 27 is a graph which demonstrates the behavior of the corrected PLL using scaling under sample-time clocking. As before, the horizontal axis represents time in seconds, and the vertical axis represents the phase error θₖ−φₖ in radians. FIG. 27 is substantially identical to the graph of the idealized clocking set forth in FIG. 24. FIG. 28 is a graph which demonstrates the behavior of a PLL incorporating NCO scaling and omitting loop filter scaling. FIG. 28 is visually substantially identical to the plot of FIG. 27.

In a software implementation, NCO scaling may be incorporated in one embodiment by using a two-entry table lookup, with one entry for each of the possible center values of the NCO. Loop-filter scaling generally requires more detailed numerics for an efficient fixed-point implementation. However, as demonstrated by FIG. 28, loop filter scaling can generally be omitted with negligible degradation in the performance of the PLL. In particular, because the loop-filter output is in the range (−π,π), the degradation introduced is typically no more than π/T radians, which is less than 1/10 of a degree for the case of 27 MHz sampling. Further, this worst case situation corresponds to the PLL operating at the most extreme frequency offset that in can handle. In more typical cases, with the PLL operating near center frequency, the performance degradation is even less.

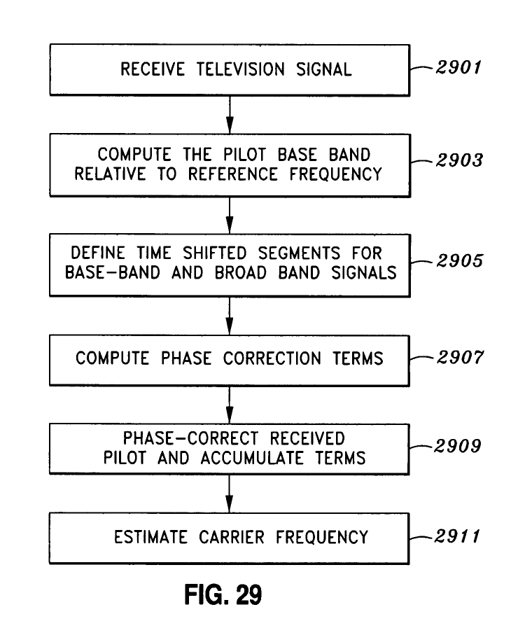

FIG. 29 is a flowchart demonstrating a method for acquiring a pilot frequency in accordance with an embodiment of the present invention. In step 2901, the receiving apparatus (such as a mobile device) receives the television signal in which the pilot signal is embedded, The processor in the receiver computes a baseband version of the pilot signal relative to a reference frequency at the receiver (step 2903). Then, time-shifted segments are defined for both the broadband and baseband versions of the pilot signal (step 2905). Phase-correction terms are computed using both of the time-shifted broadband and baseband segments (step 2907). The received pilot signal is then phase-corrected and accumulated using the newly-computed phase-correction terms (step 2909). Finally, the carrier frequency of the pilot signal is estimated using any number of known techniques (step 2911), including, for example using a Fourier transform to ultimately determine an appropriate correlation peak.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A method of estimating a frequency of a pilot signal at a receiving device, comprising:
computing a baseband version of the pilot signal relative to a reference frequency;
defining time-shifted segments for the pilot signal and for the baseband version of the pilot signal;
computing, for each of the time-shifted segments, phase correction terms using the pilot signal and the baseband version of the pilot signal;
phase-correcting the each of the time-shifted segments by multiplying the each of the time-shifted segments by its associated phase-correction term;
accumulating the phase-corrected time shifted-segments; and
estimating the pilot frequency using the accumulated phase-corrected time-shifted segments.

2. The method of claim 1 wherein the estimating the pilot frequency is performed by computing the Fourier Transform of the accumulated phase-corrected time-shifted segments.

3. The method of claim 1 wherein the receiving device comprises a device for facilitating a determination of position location using television broadcast signals.

4. The method of claim 1 wherein the estimating the frequency of the pilot signal is performed in software using a processor.

5. The method of claim 4 wherein the processor comprises a digital signal processor.

6. The method of claim 1 wherein the pilot signal comprises a component of a television broadcast signal.

7. The method of claim 6 wherein the television broadcast signal comprises a European Telecommunications Standards Institute (ETSI) Digital Video Broadcasting—Terrestrial (DVB-T) signal.

8. The method of claim 6 wherein the television broadcast signal comprises continual pilot carriers and scattered pilot carriers.

9. The method of claim 6 wherein the television broadcast signal comprises a Japanese Integrated Services Digital Broadcasting-Terrestrial (ISDB-T) signal.

10. The method of claim 6 wherein the television broadcast signal comprises an analog television signal.

11. The method of claim 6 wherein the television broadcast signal comprises an American Television Standards Committee (ATSC) digital television signal.

12. The method of claim 1 further comprising determining, using the estimated pilot frequency, a baseband version of a television broadcast signal in which the pilot signal is embedded.

13. The method of claim 12 further comprising determining a pseudo-range value for the television broadcast signal.

14. The method of claim 13 wherein the pseudo-range determining is performed by the receiving device.

15. The method of claim 1 further comprising tracking, using a phase-locked loop, a phase of the pilot signal.

16. A receiving apparatus for estimating a pilot frequency of a television broadcast signal, comprising:
(a) an antenna for receiving the television broadcast signal;
(b) a filter coupled to the antenna for filtering the television broadcast signal;
(c) an amplifier coupled to the filter;
(d) an analog-to-digital converter coupled to the amplifier for digitizing the television broadcast signal; and
(e) a processor coupled to the analog-to-digital converter, the processor configured to estimate the pilot frequency by:
(i) computing a baseband version of the pilot signal relative to a reference frequency;
(ii) defining time-shifted segments for the pilot signal and for the baseband version of the pilot signal;
(iii) computing, for each of the time-shifted segments, phase correction terms using the pilot signal and the baseband version of the pilot signal;
(iv) phase-correcting the each of the time-shifted segments;
(v) accumulating the phase-corrected time shifted-segments; and
(vi) estimating the pilot frequency using the accumulated phase-corrected time-shifted segments.

17. The receiving apparatus of claim 16 wherein the processor comprises a digital signal processor (DSP).

18. The receiving apparatus of claim 16 wherein the television broadcast signal comprises an American Television Standards Committee (ATSC) digital television signal.

19. The receiving apparatus of claim 16 wherein the processor is further configured to track, using a phase-locked loop, a phase of the pilot signal.

20. The receiving apparatus of claim 16 wherein the estimating each corresponding phase offset further comprises using a filter.

21. A receiver circuit for estimating the pilot frequency of a television broadcast signal, comprising:
an antenna for receiving the television broadcast signal;
filtering and amplifying circuitry coupled to the antenna;
an analog to digital converter coupled to the filtering and amplifying circuitry;
a digital processor coupled to the analog to digital converter for receiving a digitized version of the television signal, the processor configured to estimate the pilot frequency within the television broadcast signal by using an ideal pilot carrier frequency estimate and by selecting a sufficient number of segments of the television broadcast signal to produce a threshold signal-to-noise ratio; and
a memory circuit coupled to the digital processor.

22. The receiver circuit of claim 21 further comprising a GPS receiver coupled to the digital processor and configured to provide a stable oscillator from which the ideal pilot carrier frequency can be calculated.

23. The receiver circuit of claim 21 wherein the estimating the pilot frequency is performed by computing the Fourier Transform of a plurality of accumulated phase-corrected time-shifted segments.

24. The receiver circuit of claim 21 wherein the receiving device comprises a device for facilitating a determination of position location using television broadcast signals.

25. The receiver circuit of claim 21 wherein the digital processor comprises a digital signal processor.

26. The receiver circuit of claim 21 wherein the pilot signal comprises a component of a television broadcast signal.

27. The receiver circuit of claim 21 wherein the television broadcast signal comprises a European Telecommunications Standards Institute (ETSI) Digital Video Broadcasting—Terrestrial (DVB-T) signal.

28. The receiver circuit of claim 21 wherein the television broadcast signal comprises continual pilot carriers and scattered pilot carriers.

29. The receiver circuit of claim 21 wherein the television broadcast signal comprises a Japanese Integrated Services Digital Broadcasting-Terrestrial (ISDB-T) signal.

30. The receiver circuit of claim 21 wherein the television broadcast signal comprises an analog television signal.

31. The receiver circuit of claim 21 wherein the television broadcast signal comprises an American Television Standards Committee (ATSC) digital television signal.

32. The receiver circuit of claim 21 wherein the estimated pilot frequency is used to determine a baseband version of a television broadcast signal in which the pilot signal is embedded.

33. The method of claim 21 wherein the digital processor is further configured to track, using a phase-locked loop, a phase of the pilot signal.

34. A receiver circuit for estimating the pilot frequency of a television broadcast signal, comprising:
an antenna for receiving the television broadcast signal;
filtering and amplifying circuitry coupled to the antenna;
an analog to digital converter coupled to the filtering and amplifying circuitry;
a local oscillator;
a digital processor coupled to the analog to digital converter and to the local oscillator for receiving a digitized version of the television signal, the processor configured to estimate the pilot frequency within the television broadcast signal and to calibrate the local oscillator using the estimated pilot frequency; and
a memory circuit coupled to the digital processor.

35. The receiver circuit of claim 34, further comprising a GPS receiver coupled to the digital processor.

36. A receiver comprising a phase-locked loop (PLL) for tracking the phase of a pilot signal in a television broadcast signal having segments comprising a non-integer number of samples, the PLL comprising:
a loop filter;
a numerically-controlled-oscillator (NCO) coupled to the loop filter, the NCO comprising an output having an estimated phase value; and
a phase detector coupled to the loop filter for comparing the phase of the pilot signal with the estimated phase value output; wherein a center frequency of the NCO is scaled by a quantity sufficient to adjust the estimated phase value output from the NCO to reduce an average jitter value in the estimated phase value output below a threshold level.

37. The receiver of claim 36 wherein the PLL is implemented in software.

38. The receiver of claim 36 wherein the scaled quantity is equal to a multiple of a segment divided by a period of the segment.

39. The receiver of claim 36, wherein the loop filter is scaled to further reduce the average jitter value in the estimated phase value output.

40. The receiver of claim 37, wherein the NCO scaling is performed in software using a lookup table.

41. The receiver of claim 37, wherein phase values in the PLL are represented as signed integers.

42. Computer-readable media embodying a program of instructions executable by a computer program to perform a method of estimating a pilot frequency embedded in a television broadcast signal, the method comprising:
computing a baseband version of the pilot signal relative to a reference frequency;
defining time-shifted segments for the pilot signal and for the baseband version of the pilot signal; computing, for each of the time-shifted segments, phase correction terms using the pilot signal and the baseband version of the pilot signal; phase-correcting the each of the time-shifted segments by multiplying the each of the time-shifted segments by its associated phase-correction term; accumulating the phase-corrected time shifted-segments; and estimating the pilot frequency using the accumulated phase-corrected time-shifted segments.
